(19) United States
(12) Patent Application Publication
(10) Pub. No.: US 2025/0111675 A1
(43) Pub. Date: Apr. 3, 2025

(54) MEDIA TREND DETECTION AND MAINTENANCE AT A CONTENT SHARING PLATFORM

(71) Applicant: Google LLC, Mountain View, CA (US)

(72) Inventors: Hui Miao, Palo Alto, CA (US); Chun-Te Chu, Bellevue, WA (US); Mingyan Gao, Los Altos, CA (US); Huanfen Yao, Dublin, CA (US); Ting Liu, Los Angeles, CA (US); Long Zhao, Los Angeles, CA (US); Liangzhe Yuan, Los Angeles, CA (US); Yukun Zhu, Shoreline, WA (US); Vinay Kumar Bettadapura, San Jose, CA (US); Ye Jin, Mountain View, CA (US)

(21) Appl. No.: 18/900,467

(22) Filed: Sep. 27, 2024

Related U.S. Application Data
(60) Provisional application No. 63/587,047, filed on Sep. 29, 2023.

(51) Int. Cl. G06V 20/40; G06V 10/74; G06V 10/75; G06V 10/762; G06V 10/80

(52) U.S. Cl. CPC G06V 20/48; G06V 10/751; G06V 10/761; G06V 10/762; G06V 10/806; G06V 20/46

(57) ABSTRACT

Methods and systems for media trend detection and maintenance are provided herein. A set of media items each having common media characteristics is identified. A set of pose values is determined for each respective media item of the set of media items. Each pose value is associated with a particular predefined pose for objects depicted by the set of media items. A set of distance scores is calculated. Each distance score represents a distance between the respective set of pose values determined for a media item and a respective set of pose values determined for an additional media item. A coherence score is determined for the set of media items based on the calculated set of distance scores. Responsive to a determination that the coherence score satisfies one or more coherence criteria, a determination is made that the set of media items corresponds to a media trend of a platform.

### RELATED APPLICATIONS

This non-provisional application claims priority to U.S. Provisional Patent Application No. 63/587,047, filed Sep. 29, 2023, entitled “Fine Grained Media Trend Representation and Detection Algorithms,” which is incorporated herein by reference in its entirety for all purposes.

### TECHNICAL FIELD

Aspects and implementations of the present disclosure relate to media trend detection and maintenance at a content sharing platform.

### BACKGROUND

A platform (e.g., a content sharing platform, etc.) can enable to users share content with other users of the platform. For example, a user of the platform can provide a media item (e.g., a video item, etc.) to the platform to be accessible by other users of the platform. The platform can include the media item in a media item corpus of which the platform selects media items for sharing with users based on user interest. In some instances, one or more media items can be associated with a media trend. Media items associated with a media trend share a common concept or format that inspire the media item to be widely shared between users across the platform. In other instances, a media item can be associated with one or more other media characteristics. Detecting a media trend, identifying media items that are associated with the media trend, and determining other media characteristics of a media item can be time consuming and/or resource intensive for the platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying a set of media items each having a set of common media characteristics. The method further includes determining a set of pose values for each respective media item of the set of media items. Each pose value of a respective set of pose values determined for the respective media item is associated with a particular pose of a set of predefined poses for objects depicted by the set of media items. The method further includes calculating a set of distance scores. Each of the set of distance scores represents a distance between the respective set of pose values determined for the respective media item of the set of media items and a respective set of pose values determined for an additional media item of the set of media items. The method further includes determining a coherence score for the set of media items based on the calculated set of distance scores. The method further includes, responsive to determining that the determined coherence score satisfies one or more coherence criteria, determining that the set of media items corresponds to a media trend of a platform.

In some implementations, identifying the set of media items each having the set of common media characteristics includes obtaining audiovisual embeddings for each of the set of media items. A respective audiovisual embedding represents one or more audiovisual features of a respective media item. The method further includes determining, based on the obtained audiovisual embeddings, that the set of media items share the set of common media characteristics.

In some implementations, obtaining the audiovisual embeddings for each of the set of media items includes obtaining, based on an output of an image encoder, a video embedding representing visual features of the respective media item. The method further includes obtaining, based on an output of an audio encoder, an audio embedding representing audio features of an audio signal of the respective media item. The method further includes generating the respective audiovisual embedding based on fused audiovisual data comprising the obtained video embedding and the obtained audio embedding.

In some implementations, determining the set of pose values for each respective media item of the set of media items comprises. The method further includes obtaining, for each video frame of a sequence of video frames of a respective media item, a pose embedding representing the particular pose of an object depicted by the respective video frame. The method further includes extracting a pose value for the particular pose from the pose embedding. The method further includes updating the set of pose values to include the extracted pose value.

In some implementations, obtaining the pose embedding includes extracting the pose embedding from one or more audiovisual embeddings associated with the respective media item, or extracting the pose embedding from one or more outputs of a pose encoder.

In some implementations, determining the coherence score includes determining a cluster size associated with the set of media items, as defined by the calculated set of distance scores, wherein the coherence score reflects the determined cluster size.

In some implementations, the method further includes determining, based on at least one of a set of audiovisual embeddings generated for the set of media items or a set of textual embeddings generated for the set of media items, a creation history for each of the set of media items. The method further includes determining a degree of similarity between creation histories determined for respective media items of the set of media items, wherein the coherence score further reflects the determined degree of similarity.

In some implementations, determining that the determined coherence score satisfies the one or more coherence criteria includes at least one of determining that the determined coherence score exceeds a threshold coherence score, or determining that the determined coherence score is higher than a coherence score for another set of media items.

In some implementations, the method further includes providing at least one of a set of embeddings associated with the set of media items, the determined set of pose values or the calculated set of distance scores as an input to an artificial intelligence (AI) model trained to predict coherence scores for media items of a platform. Determining the coherence score for the plurality of media items based on the calculated set of distance scores includes extracting the coherence score from one or more outputs of the AI model.

An aspect of the disclosure provides a computer-implemented method that includes identifying a media item depicting an object having a set of distinct poses. The method further includes obtaining one or more pose embeddings for the media item. Each of the one or more pose embeddings represent a visual feature of a respective distinct pose of the set of poses of the object. The method further includes identifying one or more additional pose embeddings for an additional media item depicting an additional object. The one or more additional pose embeddings represent additional visual features of additional poses of the additional object. The method further includes calculating a distance between the one or more pose embeddings for the media item and the one or more additional pose embeddings for the additional media item. The method further includes determining, based on the calculated distance, whether at least one of the media item or an additional media item are associated with a media trend of a platform.

In some implementations, obtaining the one or more pose embeddings for the media item includes generating a set of audiovisual embeddings representing audiovisual features of the media item. The method further includes extracting the one or more pose embeddings from the generated set of audiovisual embeddings.

In some implementations, generating the set of audiovisual embeddings includes obtaining, based on an output of an image encoder, a video embedding representing visual features of the media item. The method further includes obtaining, based on an output of an audio encoder, an audio embedding representing audio features of an audio signal of the media item. The method further includes generating a respective audiovisual embedding based on fused audiovisual data including the obtained video embedding and the obtained audio embedding. The method further includes updating the set of audiovisual embeddings to include the generated respective audiovisual embedding.

In some implementations, obtaining the one or more pose embeddings includes providing a sequence of video frames of the media item as an input to a pose encoder. The method further includes extracting the one or more pose embeddings from one or more outputs of the pose encoder.

In some implementations, identifying one or more additional pose embeddings for the additional media item includes accessing a data store that stores embeddings for media items designated as template media items for one or more media trends of the platform. The method further includes extracting the one or more additional pose embeddings from the data store.

In some implementations, calculating the distance between the one or more pose embeddings for the media item and the one or more additional pose embeddings for the additional media item includes determining a first set of pose values for the first media item based on the one or more pose embeddings and a second set of pose values for the additional media item based on the one or more additional pose embeddings. The method further includes determining a difference between the first set of pose values and the second set of pose values, wherein the calculated distance represents the determined difference.

In some implementations, calculated distance between the one or more pose embeddings for the media item and the one or more additional pose embeddings for the additional media item is a Jaccard distance.

An aspect of the disclosure provides a computer-implemented method that includes identifying a set of media items associated with a media trend of a platform. The method further includes determining a set of common audiovisual features of the set of media items. Each of the set of common audiovisual features pertain to the media trend. The method further includes identifying, among the set of media items, a media item that satisfies one or more template criteria in view of the determined set of common audiovisual features of the set of media items. The method further includes determining whether an additional media item is associated with the media trend based on a degree of similarity between audiovisual features of the identified media item and the additional media item.

In some implementations, determining the set of common audiovisual features of the set of media items includes obtaining, for each of the set of media items, a set of audiovisual embeddings representing audiovisual features of a respective media item. The method further includes identifying one or more audiovisual embeddings that are common to each set of audiovisual embeddings associated with the respective media item of the set of media items. The method further includes extracting one or more audiovisual features from the identified one or more audiovisual embeddings.

In some implementations, identifying a media item that satisfies one or more template criteria in view of the determined set of common audiovisual features includes determining that at least one of a number of audiovisual features shared between the media item and the set of common audiovisual features is larger than for other media items of the set of media items, or a degree of similarity between the audiovisual features shared between the media item and the set of common audiovisual features is larger than for other media items of the set of media items.

In some implementations, the method further includes identifying one or more audiovisual embeddings of the identified media item that corresponds to the determined set of common audiovisual features of the set of media items. The method further includes designating the identified one or more audiovisual embeddings at a memory as template data associated with the media trend. The method further includes determining the degree of similarity between the audiovisual features of the identified media item and the additional media item based on the designation.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example media item manager, and an example trend engine, in accordance with implementations of the present disclosure.

FIG. 3 is a block diagram of an example trend engine, in accordance with implementations of the present disclosure.

FIG. 4 is a block diagram of an example method for media trend detection of content sharing platforms, in accordance with implementations of the present disclosure.

FIG. 5 illustrates an example of determining a coherence between media items of a platform, in accordance with implementations of the present disclosure.

FIG. 6 depicts an example of comparing media item embeddings for media item characterization, in accordance with implementations of the present disclosure.

FIG. 7 is a block diagram of another example method for media trend detection of content sharing platforms, in accordance with implementations of the present disclosure.

FIG. 8 is a block diagram of an example method for media trend maintenance, in accordance with implementations of the present disclosure.

FIG. 9 is a block diagram of an illustrative predictive system, in accordance with implementations of the present disclosure.

FIG. 10 is a block diagram illustrating an exemplary computer system, in accordance with implementations of the present disclosure.

### DETAILED DESCRIPTION OF THE DRAWINGS

Aspects of the present disclosure generally relate to media item characterization based on multimodal embeddings. A platform (e.g., a content sharing platform) can enable users to share media items (e.g., video items, audio items, etc.) with other users of the platform. Some media items can include and/or share particular media item characteristics. For example, some media items can be part of or otherwise associated with a media trend. A media trend refers to a phenomenon in which a set of media items share a common format or concept and, in some instances, are distributed widely among users of a platform. Media items that are associated with a media trend may share common visual features (e.g., dance moves, poses, actions, etc.), common audio features (e.g., songs, sound bites, etc.), common metadata (e.g., hashtags, titles, etc.), and so forth. One example of a media trend can include a dance challenge trend, where associated media items depict users performing the same or a similar dance moves to a common audio signal. It can be useful for a system to identify media items that share common media item characteristics, as such identified media items can be used to determine and/or predict an overall quality and/or classification of videos included in a video corpus.

Users may provide (e.g., upload) a significantly large number of media items to the platform each day (e.g., hundreds of thousands, millions, etc.). Given such large number of uploaded media items, it can be challenging for the platform to perform media characterization tasks, such as detecting media trends among such media items and/or previously uploaded media items. For instance, on a given day, multiple users may upload media items to the platform that share a common format or concept. Users of a platform may want to be informed of new media trends that emerge at a platform and/or which media items of the platform are part of the media trend (e.g., so the users can participate in the media trend by uploading a media item sharing the common format or concept of the media trend). It can be difficult for a platform to identify, of the large number of media items uploaded by users each day, whether a new media trend has emerged and/or which media items are associated with the media trend. It can further be difficult for systems to perform other types of media characterization tasks, including but not limited to video quality prediction and/or video classification, given the large number of uploaded media items.

Some conventional systems perform media item characterization for uploaded media items based on audiovisual features of the media items and/or user-provided metadata. For instance, a conventional platform may detect that a significant number of media items uploaded within a particular time period share a common audio signal (e.g., a common song). The conventional platform may determine whether metadata (e.g., titles, captions, hashtags, etc.) provided by users associated with such media items share common features (e.g., common words in the title or caption, common hashtags, etc.) and, if so, may determine that such media items are associated with a media trend. In an illustrative example, the platform may determine that media items including the song titled “I love to dance” are each associated with the common hashtag “#lovetodancechallenge.” Therefore, the conventional platform may detect that a media trend has emerged and such media items are associated with the detected media trend. Upon detecting the media trend, the conventional platform may associate each newly uploaded media item having the common song and/or associated with the hashtag with the media trend and, in some instances, may provide a notification to users accessing such media items.

As indicated above, users can upload a significantly large number of media items to a platform each day. It can take a significant amount of computing resources (e.g., processing cycles, memory space, etc.) to identify media items sharing common audiovisual features and determine, based on the user-provided metadata, whether such media items share common media item characteristics (e.g., are associated with a new or existing media trend). In some instances, a large portion of uploaded media items can share common audiovisual features and may share some common metadata features, but in fact may not actually share common media item characteristics (e.g., may not be related to the same media trend). By basing media item characterization on common user-provided metadata, a conventional platform may not be able to accurately determine characteristics of media items uploaded to a platform, such as detecting whether a set of media items are part of the same media trend or whether the media items, although having some commonalities, are not part of the same media trend. Further, the overall characteristics of media items in a corpus can evolve multiple times during a time period (e.g., based on the characteristics of the media items being provided to the platform). Accordingly, media items of a media trend that are uploaded earlier in the time period may have different user-provided metadata than media items of the media trend that are uploaded later in the time period (e.g., due to the evolution of a media trend during the time period). Therefore, conventional platforms may be unable to accurately detect that such earlier uploaded media items and/or later uploaded media items share common media item characteristics (e.g., are part of the same media trend). In some instances, the system therefore is unable to accurately notify users of the media trend and/or which media items are part of the media trend and therefore the computing resources consumed to identify the media trend are wasted. Further, a user that wishes to participate in a media trend and/or find media items having particular characteristics may spend additional time searching through media items of the platform, which may consume further computing resources. Such computing resources are therefore unavailable to other processes of the system, which increases an overall latency and decreases an overall efficiency of the system.

Implementations of the present disclosure address the above and other deficiencies by providing methods and systems for media trend detection and maintenance at a content sharing platform. In some embodiments, a system can perform one or more operations associated with detecting an emerging media trend among media items uploaded to the content sharing platform. For instance, the system can identify a set of media items that each have a set of common media characteristics. The common media characteristics can include, for example, a common audio signal (e.g., song), common metadata (e.g., a common title, common keywords or tags, etc.), common visual features, and so forth. In an illustrative example, the system can identify a set of media items each including the song “I love to dance” and/or sharing the common hashtag “#lovetodancechallenge.” Each of the set of media items can depict one or more performers performing dance moves based on the song. The system can determine a set of pose values for each media item of the identified set of media items, where each pose value can be associated with a particular pose of a set of pre-defined poses for objects depicted by the set of media items. In some embodiments, the system can determine the set of pose values for a media item based on a set of pose embeddings for a respective media item, where each pose embedding represents visual features of a pose of a performer depicted by a video frame (or sequence of video frames) of the media item. Details regarding determining a set of pose values for a media item are provided below.

Upon determining the set of pose values for each respective media item of the set of media items, the system can calculate a set of distance scores representing a distance between a set of pose values determined for a respective media item and a set of pose values determined for an additional media item of the set. The system can calculate a coherence score for the set of media items based on the calculated set of distance scores. The coherence score indicates a size of a data cluster including each of the set of media items, in view of the calculated set of distance scores, and/or a degree of similarity of a creation history between each of the set of media items. A creation history of a media item can include or indicate one or more other media items of a platform that inspired the creation of the media item, in some embodiments. Upon determining that the coherence score calculated for the set of media items satisfies one or more coherence criteria, the system can determine that the set of media items corresponds to a media trend of the platform.

In additional or alternative embodiments, the system can perform one or more operations associated with determining whether media item provided to the system (e.g., uploaded by a user) is associated with a previously detected media trend. In some embodiments, a media item uploaded to a platform can depict an object having multiple distinct poses. The system can obtain one or more pose embeddings for the media item, where each of the one or more pose embeddings represents a visual feature of a respective pose of the object (e.g., as depicted by a video frame or sequence of video frames). The system can identify one or more additional embeddings for an additional media item depicting an additional object, where the additional embeddings represent visual features of additional poses of the additional object. In some embodiments, the additional media item may be determined to be associated with a media trend detected at the platform, in accordance with embodiments described herein. The system can calculate a distance between the pose embeddings for the media item and the additional pose embeddings for the additional media item and can determine, based on the calculated distance, whether the media item is also associated with the media trend. For example, upon determining that the calculated distance falls below a threshold distance, the system can determine that the media item is also associated with the media trend (e.g., as the visual features of the poses of the object depicted by the media item match or approximately match the visual features of the additional poses of the additional object depicted by the additional media item).

In yet additional or alternative embodiments, the system can perform one or more operations associated with maintaining media trends detected at a platform. Maintenance of a media trend refers to the identification of audiovisual characteristics shared by media items of the media trend that best represent the format or concept of the media trend. The system can compare such audiovisual characteristics to audiovisual characteristics of newly uploaded media items of the platform, to maintain accurate detection of the media trend. In some embodiments, the system can identify a set of media items that are associated with a detected media trend of a platform and can determine a set of common audiovisual characteristics of each of the set of media items. In some embodiments, the system can determine the set of common audiovisual characteristics by identifying embeddings (e.g., audiovisual embeddings, pose embeddings, etc.) of each of the set of media items that indicate the same or similar visual and/or audio features. Such visual and/or audio features can define the common audiovisual characteristics of the media trend, as such visual and/or audio features indicate the common format or concept of which the media trend is composed. The system can identify a particular media item that satisfies one or more template criteria in view of the determined set of common audiovisual characteristics, in some embodiments. A media item can satisfy the one or more template criteria by having more audio and/or visual features that correspond to the common audiovisual characteristics than other media items, in some embodiments. Further details regarding the template criteria are described herein. Upon identification of a media item that satisfies the one or more template criteria, the system can compare audiovisual features of such media item to the audiovisual features of newly uploaded media items to determine whether the newly uploaded media items also correspond to the media trend, as described herein.

In some embodiments, one or more AI-based techniques can be applied to detect media trends and/or perform media trend maintenance, as described herein. For example, the system can calculate or otherwise obtain distance scores and/or a coherence scores for a set of media items (e.g., for detecting a newly emerging media trend), based on one or more outputs of an AI model trained to predict distance scores and/or coherence scores for a set of media items based on visual features of the set of media items. In another example, the system can calculate or otherwise determine a distance between visual features of a newly uploaded media items and media items associated with a previously detected media trend based on one or more outputs of an AI model trained to predict a distance and/or similarity between visual features of two or more media items. In yet another example, the system can identify a media item that satisfies one or more template criteria based on one or more outputs of an AI model trained to predict a media item having audiovisual characteristics that best represents the format or concept of a detected media trend. Further details regarding such AI-based techniques are described herein.

Aspects of the present disclosure provide techniques for media trend detection and media trend maintenance at a content sharing platform. As described above, the system can detect a newly emerging media trend at a platform and/or can determine whether a newly uploaded media item corresponds to a previously detected media trend based on audiovisual features of content of media items of the platform. By determining whether a media item is part of a media trend based on the audiovisual features of the media item (e.g., instead of user-provided metadata for the media items), the system is able to more accurately determine whether the content of the media item matches or approximately matches content of other media items identified as part of the trend, in accordance with the common format or concept of the media trend. Further, by evaluating whether media items are part of a media trend based on the audiovisual features, the system is more quickly able to detect when a new media trend has emerged and/or has evolved, as outputs of the AI model can indicate to the system that a growing set of media items sharing common audiovisual features is identified. Therefore, the system is able to more accurately and quickly identify and surface media trends to users, thereby reducing the amount of computing resources wasted by the system to detect such media trends and improving the overall efficiency and reducing the overall latency of the system.

It should be noted that although embodiments of the present disclosure relate to media trend detection among media items of a platform, such embodiments can be applied to any type of media characterization task associated with media items of a system. For example, embodiments of the present disclosure can be applied for video quality prediction and/or video classification. In another, embodiments of the present disclosure can be applied to identify media items that share common media item characteristics.

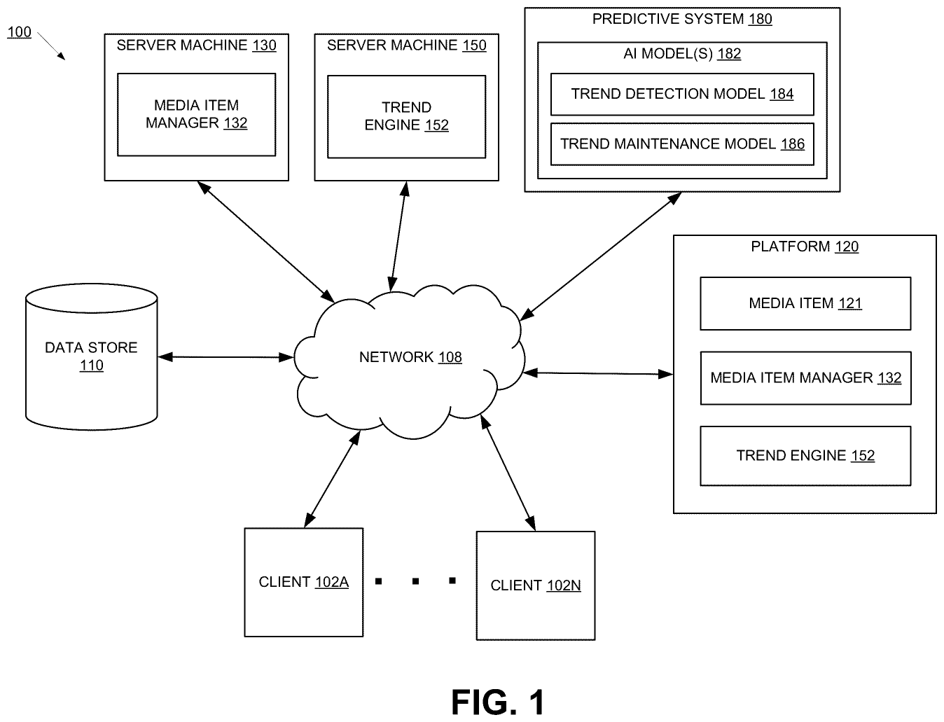

FIG. 1 illustrates an example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Trend engine 152 can detect one or more media trends among media items 121 of platform 120 and/or can determine whether a respective media item 121 is associated with a media trend. A media trend refers to a phenomenon in which content of a set of media items share a common format or concept and, in some instances, are shared widely among users of platform 120. Media items that are associated with a media trend may share common visual features (e.g., dance moves, poses, actions, etc.), common audio features (e.g., songs, sound bites, etc.), common metadata (e.g., titles, captions, hashtags, etc.), and so forth. In some instances, a creator can upload to platform 120 (e.g., via a UI of a client device 102) a media item 121 including content having a particular format or concept for sharing with other users of platform 120. One or more other users of platform 120 can access the creator's media item 121 and, in some instances, may be inspired to create their own media items 121 that share the particular format or concept of the accessed media item 121. In some instances, a significantly large number of users (e.g., hundreds, thousands, millions, etc.) can create media items 121 sharing the particular format or concept of the original creator's media item 121. In accordance with embodiments described herein, trend engine 152 may detect such media items 121 sharing the particular format or concept as a media trend. Examples of media trends can include, but are not limited to, dance trends or dance challenge trends, memes or pop culture trends, branded hashtag challenge trends, and so forth. For purposes of example and illustration only, some embodiments and examples herein are described with respect to a dance trend or a dance challenge trend. It should be noted that such embodiments and examples are not intended to be limiting and embodiments of the present disclosure can be applied to any kind of media trend for any type of media item (e.g., a video item, an audio item, an image item, etc.).

As described herein, trend engine 152 may detect a media trend that originated based on a media item 121 provided by a particular creator (or group of creators). Such media item 121 is referred to herein as a “seed” media item 121. In some instances, the common format or concept shared by media items 121 of a trend may deviate from the original format or concept of the seed media item 121 that initiated the trend. In some embodiments, trend engine 152 may identify a media item 121 (or a set of media items) associated with the media trend of which the common format or concept is determined to initiate the deviation from the original format or concept of the seed media item 121. In some embodiments, such identified media item 121 may be designated as the seed media item 121 for the media trend. In other or similar embodiments, the original media item 121 and the identified media item 121 may both be designated as seed media items 121 for the media trend.

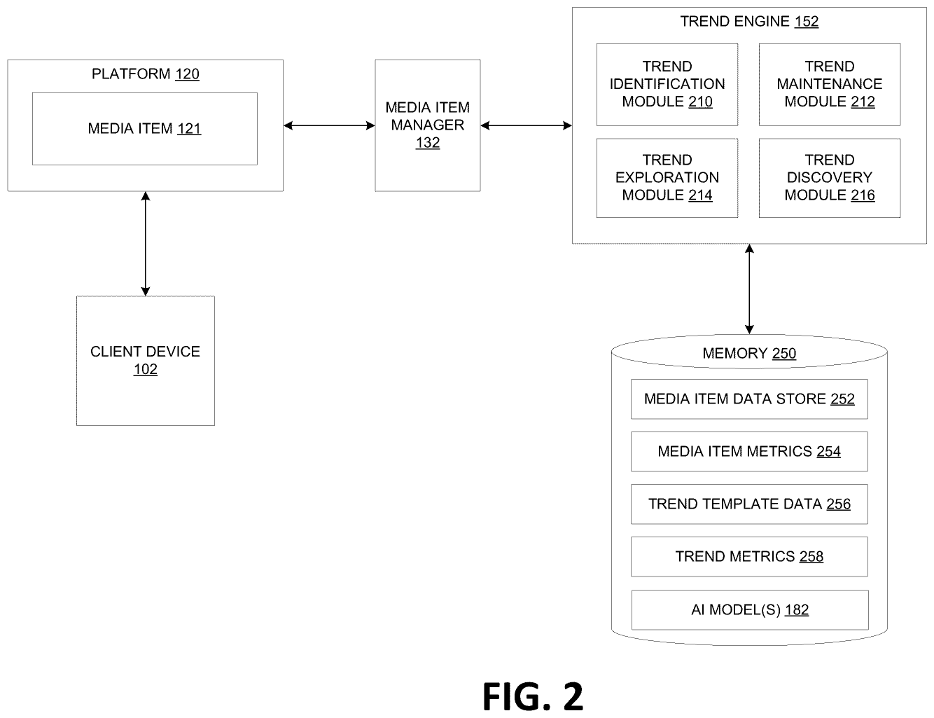

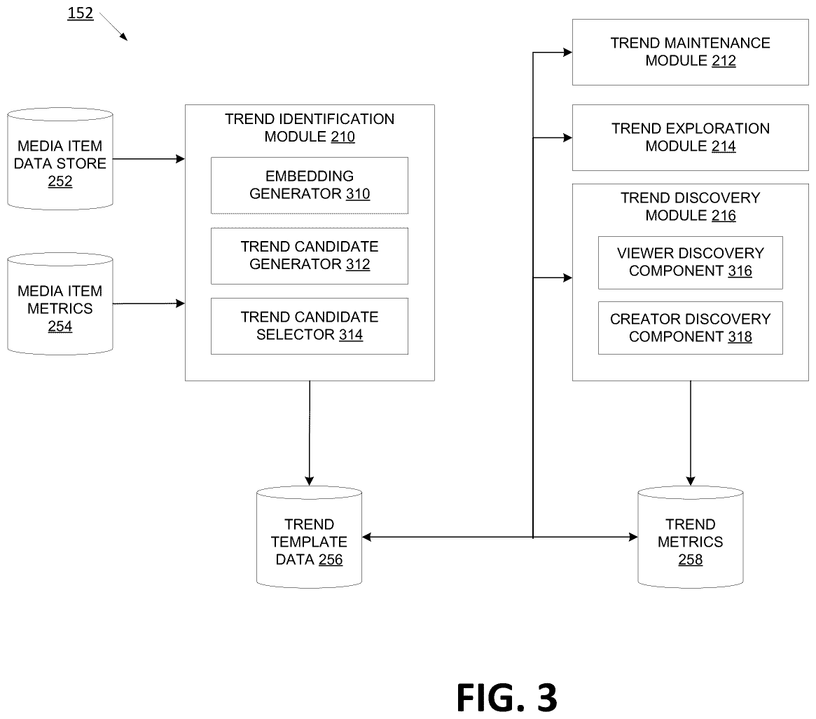

In some embodiments, trend engine 152 may determine one or more features (e.g., video features, audio features, textual features, etc.) of media items 121 of a media trend that are specific or unique to the format or concept of the media trend. Such features may define a template for the media trend for which other media items 121 replicating the media trend are to include. As described herein, trend engine 152 can determine such features and can store data indicating such features as trend template data (e.g., trend template data 256 of FIGS. 2 and 3). Trend engine 152 can determine whether subsequently uploaded media items 121 are part of a media trend by comparing features of the uploaded media items 121 to features indicated by the trend template data, in accordance with embodiments described herein. Further details regarding trend engine 152 and detecting media trends are provided herein with respect to FIGS. 2-9.

As illustrated in FIG. 1, system 100 can also include a predictive system 180, in some embodiments. Predictive system 180 can implement one or more artificial intelligence (AI) and/or machine learning (ML) techniques for performing tasks associated with media trend detection. In some embodiments, predictive system 180 can train one or more AI models 182 (e.g., a machine learning model) to detect whether a new media trend has emerged with respect to media items 121 uploaded to platform 120 and/or whether a media item 121 uploaded to platform 120 is part of a detected media trend. For purposes of explanation and example only, an AI model 182 that is trained to detect an emerging media trend is referred to as a trend detection model 184 and an AI model 182 trained to determine whether a media item 121 uploaded to platform 120 is part of a detected media trend is referred to as a trend maintenance model 186. It should be noted that while in some embodiments, functionalities of the trend detection model 184 may be separate from the functionalities of the trend maintenance model 186. However, in other or similar embodiments, functionalities of the trend detection model 184 and the trend maintenance model 186 can be performed by the same Al model 182. Further details regarding inference and training of the AI models are provided below.

It should be noted that although FIG. 1 illustrates trend engine 152 as part of platform 120, in additional or alternative embodiments, trend engine 152 can reside on one or more server machines or systems that are remote from platform 120 (e.g., server machine 130, server machine 150, predictive system 180). It should be noted that in some other implementations, the functions of server machines 130, 150, predictive system 180 and/or platform 120 can be provided by a fewer number of machines. For example, in some implementations, components and/or modules of any of server machines 130, 150 and/or predictive system 180 may be integrated into a single machine, while in other implementations components and/or modules of any of server machines 130, 150 and/or predictive system 180 may be integrated into multiple machines. In addition, in some implementations, components and/or modules of any of server machines 130, 150 and/or predictive system 180 may be integrated into platform 120.

In general, functions described in implementations as being performed by platform 120 and/or any of server machines 130, 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example media item manager 132, and an example trend engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102. As described herein, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

As illustrated in FIG. 2, trend engine 152 can include a trend identification module 210, a trend maintenance module 212, a trend exploration module 214, and/or a trend discovery module 216. Trend identification module 210 can perform one or more operations associated with trend identification, which can include identification of one or more media items 121 that may initiate or otherwise correspond to an emerging media trend and/or determine trend template data for a detected media trend. Trend maintenance module 212 can perform one or more operations associated with trend maintenance, including detecting newly uploaded media items 121 that correspond to a detected media trend and, if needed, updating trend template data 256 for a detected trend based on an evolution of the media trend over time. Trend exploration module 214 can perform one or more operations associated with trend exploration, which can include determining a context and/or a purpose of the media trend and, in some embodiments, identifying features of media items 121 of the media trend of which particular audiences of users are particularly interested. Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. It should be noted that trend engine 152 can include one or more additional or alternative modules, in some embodiments. It should also be noted that although some operations or functionalities are described with respect to particular modules of trend engine 152, any of trend identification module 210, trend maintenance module 212, trend exploration module 214, trend discovery module 216, and/or any alternative or additional modules of trend engine 152 can perform any operations pertaining to trend detection and surfacing, as described herein. Details regarding trend detection by trend engine 152 are provided below with respect to FIGS. 3-9.

In some embodiments, platform 120, media item manager 132, and/or trend engine 152, can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100. Data, data items, data structures, and/or models stored at memory 250, as depicted by FIG. 2, are described in conjunction with FIGS. 3-9.

FIG. 3 is a block diagram of an example trend engine 152, in accordance with implementations of the present disclosure. Trend engine 152 can include or otherwise correspond to trend engine 152 of FIGS. 1-2. As described above, trend engine 152 can detect when a new media trend has emerged among media items 121 provided by users of platform 120 and/or can determine whether a particular media item 121 provided by a user is associated with an existing media trend of platform 120. Further, trend engine 152 can notify users accessing media items 121 of platform 120 of the detected media trends and which media items 121 are a part of such detected media trends.

Media items 121 evaluated by trend engine 152 can be stored at media item data store 252 of memory 250, in some embodiments. In an illustrative example, a user of a client device 102 can provide a media item 121 to platform 120 to be shared with other users of platform 120. Upon receiving the media item 121, media item manager 132 (or another component of platform 120) may store the media item 121 at media item data store 252. In some embodiments, media item data store 252 can additionally or alternatively store metadata associated with a media item 121 (e.g., a title of the media item 121, a description of the media item 121, etc.). Metadata for a media item 121 may be received by platform 120 with the media item 121 and/or may be determined by platform 120 (e.g., after receiving the media item 121). Trend engine 152 may evaluate a respective media item 121 for association with a media trend at any time after the media item 121 is received by platform 120. For example, upon receiving the media item 121, trend engine 152 may perform one or more operations described herein to determine whether the media item 121 is associated with a media trend (e.g., prior to or while users of platform 120 access media item 121). In another example, platform 120 may provide users with access to media item 121 and, after a period of time (e.g., hours, days, weeks, months, etc.), trend engine 152 may evaluate whether the media item 121 is associated with a media trend, as described herein.

As described above, trend identification module 210 can perform one or more operations associated with trend identification. Trend identification refers to the detection of media trends among media items 121 of platform 120 and/or determining whether a newly uploaded media item 121 corresponds to a previously detected media trend. In some embodiments, trend identification module 210 can include an embedding generator 310, a trend candidate generator 312, and/or a trend candidate selector 314. Embedding generator 310 can generate one or more embeddings representing features of a media item 121. An embedding refers to a representation of data (e.g., usually high-dimensional and complex) in a lower-dimensional vector space. Embeddings can transform complex data types (e.g., text, images, audio, etc.) into numerical vectors that can be processed and analyzed more efficiently by AI models or other such algorithms (e.g., AI model(s) 182). In some embodiments, embedding generator 310 can generate a set of audiovisual embeddings that represent audiovisual features of a media item 121. Embedding generator 310 can additionally or alternatively generate a set of textual embeddings that represent textual features of the media item 121. The set of audiovisual embeddings can represent one or more audiovisual features of the media item 121 and the set of textual embeddings can represent one or more textual features of the media item 121.

In some embodiments, embedding generator 310 can generate the set of audiovisual embeddings by obtaining video embeddings and audio embeddings for the media item 121 and performing one or more operations to fuse the video embeddings with the audio embeddings. The video embeddings can be obtained based on one or more outputs of an image encoder (e.g., a vision transformer, a convolutional neural network, etc.) and can represent video features of one or more frames of the media item 121, including spatial features (e.g., detected objects, people or scenery, shapes, colors, textures, etc.), temporal features (e.g., how the objects move or change over time), scene context features (e.g., an environment of a scene, background information of the video content), and so forth. The audio embeddings can be obtained based on one or more outputs of an audio encoder (e.g., an audio spectrogram transformer, etc.) and can represent audio features of the one or more frames, including pitch, timbre, rhythm, speech content (e.g., phonemes, syllables, word, etc.), speaker characteristics, environmental sounds, spectral features (e.g., frequency content), temporal dynamics (e.g., how sound evolves overtime), and so forth. Embedding generator 310 can generate the set of audiovisual embeddings by performing one or more concatenation operations with respect to the video embeddings and the audio embeddings and, in some embodiments, performing one or more attention pooling operations with respect to the concatenated video and audio embeddings. Embedding generator 310 can generate the set of textual embeddings for the media item 121 by providing textual data associated with the media item 121 (e.g., a title, a description, one or more keywords or hashtags, a transcript generated based on one or more audio signals associated with the media item 121, etc.) as an input to a text encoder (e.g., a bidirectional encoder representations from transformations (BERT) encoder, a robustly optimized BERT approach (RoBERTa) encoder, a generative pre-trained transformer (GPT) encoder, a text-to-text transfer transformer (T5) encoder, etc.). Further details regarding generating the audiovisual embeddings and/or the textual embeddings are provided herein.

In some embodiments, embedding generator 310 can store the embeddings generated or otherwise obtained for a media item 121 at media item data store 252 (e.g., with metadata for the media item 121). In other or similar embodiments, embedding generator 310 can store the embeddings for a media item 121 at another region of memory 250 or at another memory of or accessible to components of system 100.

Trend candidate generator 312 can identify one or more media items 121 of media item data store 252 that are candidates for association with a media trend. In some embodiments, trend candidate generator 312 can provide audiovisual embeddings and textual embeddings generated for media items 121 of media item data store 252 as an input to one or more AI models 182. The AI model(s) 182 can include a trend detection model 184, which can be trained to perform one or more clustering operations to identify clusters or groups of media items 121 sharing common or similar video and/or audio features, in view of their embeddings. In some embodiments, the one or more clustering operations can include a k-means clustering operation, a hierarchical clustering operation, gaussian mixture model (GMM) operation, or any other such type of clustering operation. Trend candidate generator 312 can obtain one or more outputs of the trend detection model 184, which can indicate a distance between each of a set of media items 121 of an identified cluster or group. The distance indicated by the model outputs can indicate a distance between of the visual or audio features for each of the set of media items 121, in view of the textual features associated with such media items 121. Trend candidate generator 312 can determine that the set of media items 121 indicated by the output(s) of the trend detection model 184 are candidates for association with a media trend by determining that the distance of the output(s) satisfies one or more distance criteria (e.g., falls below a distance threshold).

Trend candidate generator 312 can identify multiple sets of media items 121 that are candidates for different media trends, in accordance with embodiments described above. Trend candidate selector 314 can select a respective set of media items 121 identified by trend candidate generator 312 that define or are otherwise associated with a media trend of platform 120. In some embodiments, trend candidate selector 314 can select a respective set of media items 121 to be associated with a media trend by determining that the respective set of media items 121 satisfy one or more media trend criteria. The media trend criteria can be defined by a developer or operator of platform 120 and can relate to commonalties of detected media trends. In an illustrative example, a media trend criterion can be that a set of media items 121 identified as a candidate for a dance challenge media trend include a song that has characteristics associated with songs for other dance challenge media trends (e.g., high tempo, upbeat lyrics, etc.). A developer or operator of platform 120 can provide the media trend criteria to trend candidate selector 314, in some embodiments, and trend candidate selector 314 can select a respective set of media items 121 for association with a media trend by determining whether the set of media items 121 satisfies the media trend criteria. In other or similar embodiments, media trend selector 314 can provide, to a client device 102 associated with the developer or operator, an indication of one or more sets of media items identified as media trend candidates. The developer or operator can provide an indication a set of media items that satisfies the media trend criteria via a UI of the client device 102, in some embodiments.

Upon selecting or otherwise identifying a respective set of media items that are associated with a media trend, trend candidate selector 314 can determine trend template data 256 for the media trend based on data associated with each of the set of media items. Trend template data 256 can include embeddings indicating one or more common audio, video, and/or textual features of each of the set of media items that are unique to the media trend (e.g., compared to other media items 121 that are not associated with the trend). In some embodiments, trend candidate selector 314 can identify audiovisual embeddings and/or the textual embeddings representing one or more visual features, audio features, and/or textual features that are common to each of the set of media items and can store such identified embeddings as trend template data 256 for media items 121 of the media trend.

In other or similar embodiments, trend candidate selector 314 can determine a particular media item 121 of the set of media items that originated the media trend and/or best represents the media trend. Trend candidate selector 314 can identify audiovisual embeddings and/or textual embeddings representing visual features, audio features, and/or textual features for the particular media item 121 and store such identified embeddings at memory 250 as trend template data 256. Trend candidate selector 314 can determine that the particular media item 121 originated the media trend by determining that such media item 121 was provided to platform 120 before the other media item 121 of the media trend, in some embodiments. In other or similar embodiments, trend candidate selector 314 can determine that such media item 121 originated the media trend based on creation journey data associated with the media item 121 and/or other media items 121 of the media trend. In some embodiments, creation journey data can be provided by or otherwise determined for creators of media items 121 and can indicate one or more media items 121 of platform 120 that inspired the creator to upload a respective media item 121. For example, a user of platform 120 can access a first media item of another user and determine to create and provide to platform 120 a second media item with content matching or approximately matching the content of the first media item. In such example, the first media item may be determined to be part of the “creation journey” of the second media item, as content of the first media item inspired the creation of the second media item. In some embodiments, a creator may provide an indication of media items 121 that are part of the “creation journey” of a provided media item 121 via a UI of a client device 102. Such indication can be included in creation journey data associated with the media item 121 (e.g., and stored as metadata at media item data store 252). In other or similar embodiments, trend candidate selector 314 (and/or another component of trend engine 152 or platform 120) can identify media items 121 that may be included in a creation journey associated with a media item 121 provided by a creator by identifying media items 121 that the creator accessed prior to providing their media item 121. In some embodiments, trend candidate selector 314 can parse creation journey data associated with each of the set of media items identified for the media trend and can identify a particular media item 121 that satisfies one or more creation journey criteria (e.g., is included in a threshold number of creation journeys of the set of media items) as best representing the media trend.

As indicated above, trend maintenance module 212 can perform one or more operations associated with trend maintenance, including detecting newly uploaded media items 121 that correspond to a detected media trend and, if needed, updating trend template data 256 for the trend based on an evolution of the media trend over time. In some embodiments, platform 120 can receive a media item 121 from a client device of a creator for sharing with other users of the platform. Upon receiving the media item 121, embedding generator 310 may generate a set of audiovisual embeddings and/or a set of textual embeddings for the media item 121, as described herein. Trend maintenance module 212 can provide the generated embeddings for the media item 121 as an input to one or more AI models 182. In some embodiments, the one or more AI model(s) 182 can include a trend maintenance model 186, which can be trained to determine whether a media trend 121 uploaded to platform 120 is part of a detected media trend (e.g., detected by trend identification module 210). In some embodiments, trend maintenance module 212 can provide the embeddings for the media item 121 as an input to the trend maintenance model 186 and can obtain one or more outputs, which can indicate whether the media item 121 is associated with a detected media trend. Responsive to determining, based on the one or more outputs of the trend maintenance model 186, that the media item 121 is associated with a detected trend, trend maintenance module 212 can update media item data store 252 to include an indication that media item 121 is associated with the detected trend.

In some embodiments, trend maintenance module 212 may determine that one or more features (e.g., video feature, audio feature, etc.) of a user provided media item 121 may correspond to a feature of media items 121 associated with a detected media trend. In such embodiments, trend maintenance module 212 may identify the trend template data 256 associated with the detected media trend and may provide the embeddings of the identified trend template data 256 as an input to trend template model 186 (e.g., with the embeddings for the user provided media item 121. In such embodiments, trend maintenance model 186 can provide one or more outputs that indicate a distance between features of the user provided media item 121 and features indicated by the provided embeddings associated with the media trend. Trend maintenance module 212 can determine whether the user provided media item 121 is associated with the media trend by determining whether the distance indicated by the one or more outputs satisfies one or more distance criteria (e.g., falls below a distance threshold).

In some embodiments, prior to providing the embeddings for the user provided media item 121 and the embeddings associated with the media trend as an input to the trend maintenance model 186, trend maintenance module 212 can determine a degree of alignment between the embeddings of the user provided media item 121 and the embeddings associated with the media trend. For example, trend maintenance module 212 can provide the embeddings of the user provided media item 121 and the embeddings associated with the media trend as an input to an alignment function (e.g., a dynamic time warping function) and can obtain, based on one or more outputs of the alignment function, an indication of a degree of alignment between one or more visual features of the user provided media item 121 and visual features represented by the embeddings for the media trend. Trend maintenance module 212 can provide the indicated degree of alignment as an input to trend maintenance model 186, which can further inform trend maintenance model 186 of the similarities and/or distance between content of the user provided media item 121 and media items 121 of the media trend. In other or similar embodiments, trend maintenance model 186 can predict the degree of alignment between the embeddings provided as an input, and the output(s) of the trend maintenance model 186 can indicate the predicted degree of alignment.

As indicated above, trend maintenance module 212 can continuously compare features of newly uploaded media items 121 to features of media items 121 associated with detected media trends to determine whether such newly uploaded media items 121 are associated with a respective media trend. In some embodiments, trend maintenance module 212 can detect that a distance between features of media items 121 associated with a detected media trend and features of newly uploaded media items 121 determined to be associated with a media trend changes overtime. For example, trend maintenance module 212 can detect that a distance value included in the output(s) of trend maintenance module 212, while still satisfying the distance criteria, are increasing overtime. Such change can indicate to trend maintenance module 212 that the media trend may be evolving since the initial identification of the media trend. In some embodiments, trend maintenance module 212 may transmit an instruction to trend identification module 210 to perform one or more media trend identification operations with respect to the newly updated media items 121 of which the deviation from the media trend is detected. Trend identification module 210 can perform the media trend identification operations with respect to such media items 121 and can determine (e.g., based on the clustering operations performed by trend candidate generator 312) whether a new media trend is detected among such media items 121. In response to determining that the new media trend is detected, trend identification module 210 can update trend template data 256 associated with the media trend to include one or more features (e.g., visual features, audio features, textual features, etc.) for such media items 121. In some embodiments, trend maintenance module 212 can perform trend maintenance operations with respect to newly uploaded media items 121 based on the updated trend template data 256 for the media trend.

Trend exploration module 214 can perform one or more operations associated with trend exploration, which can include, in some embodiments, determining a context and/or a purpose of a detected media trend and/or identifying features of media items 121 of the detected media trend of which particular audiences of users are particularly interested. In some embodiments, trend exploration module 214 can determine the context and/or purpose of the detected media trend upon detection of the media trend. For example, trend identification module 210 can detect a new media trend among media items 121 of media item store 252, as described herein, but at the time of detection, trend engine 152 may be unaware of the context or purpose of the media trend. Trend exploration module 214 can compare features of trend template data 256 (e.g., as determined for the media trend by trend identification module 210) to features of media items 121 for other media trends for which the context or purpose is known. Upon determining that one or more features (e.g., visual features, audio features, etc.) indicated by the trend template data 256 corresponds to (e.g., matches or approximately matches) features for the media items 121 for the other media trends, trend exploration module 214 can determine that the context or purpose of the detected media trend matches the context or purpose of the other media trends. In an illustrative example, the features of the trend template data can indicate that the audio signal of media items 121 of a detected media trend includes a steady beat, a fast tempo, a high or medium degree of syncopation, and so forth. Trend exploration module 214 can compare these features to features of media items 121 associated with other media trends at platform 120 and can determine, based on the comparison, that features of the detected media trend match features of media items 121 for dance challenge trends. Therefore, trend exploration module 214 can determine that the context or purpose of the detected media trend is a dance challenge. In some embodiments, trend exploration module 214 can update trend template data 256 to include an indication of the determined context or purpose for the detected media trend.

Trend exploration module 214 can also collect trend metrics 258 for a respective media trend, which includes data indicating user engagement associated with media items 121 of a particular media trend. User engagement can include, but is not limited to, viewership engagement (e.g., a number of times the media item 121 has been watched, the amount of time users spend watching the media item 121, the percentage of users who watch the entire media item 121, etc.), interaction engagement (e.g., approval or disapproval expressions provided by users, comments provided by users, a number of times users have shared the media item 121 with other users, etc.), social engagement (e.g., mentions or tags associated with the media item 121 in social media posts or comments, etc.), user retention engagement (e.g., the number of users that rewatch the media item 121, etc.), interactive engagement (e.g., user engagement with polls or quizzes associated with the media item 121), feedback engagement (e.g., user responses in surveys, reviews, etc. associated with the media item 121), and so forth. In some embodiments, trend exploration module 214 can collect user engagement data for each media item 121 associated with a respective media trend 121 determined to be associated with a media trend and can aggregate the collected user engagement data for each media trend as one or more media trend metrics 258. In an illustrative example, a media trend metric 258 for a respective media trend can indicate a factor of component of user engagement across all media items 121 associated with the respective media trend. In some embodiments, trend metrics 258 can also include data or other information associated with the characteristics of users and/or client devices that are accessing and/or engaging with media items 121 of the media trend and/or are not accessing and/or engaging with media items 121 of the media trend.

In some embodiments, trend exploration module 214 can detect when a previously detected media trend has become inactive or unsuccessful. An inactive media trend refers to a media trend of which a degree or frequency of association with newly uploaded media items 121 within a particular time period falls below a threshold degree or a threshold frequency. An unsuccessful media trend refers to a media trend of which values of media trend metrics 258 (e.g., pertaining to user access and/or user engagement) satisfy one or more unsuccessful trend criteria. For example, trend exploration module 214 can determine that a media trend is unsuccessful upon determining that an aggregate number of users that have shared media items 121 of the media trend falls below a threshold number. In another example, trend exploration module 214 can determine that a media trend is unsuccessful upon determining that an aggregate number of disapproval expressions (e.g., “dislikes”) for media items 121 of the media trend exceeds a threshold number and/or an aggregate number of approval expressions (e.g., “likes”) for media items 121 of the media trend falls below a threshold number. Upon determining that a media trend has become inactive or unsuccessful, media item manager 132 (or another component or module of trend engine 152) can perform one or more operations to update trend template data 256 to indicate that the media trend is an inactive or an unsuccessful media trend. In some embodiments, trend engine 152 can remove trend template data 256 for the inactive or unsuccessful media trend from memory 250 based on the indication.

Trend discovery module 216 can perform one or more operations associated with trend discovery, which can include surfacing media trends and/or media items 121 associated with particular media trends to users, alerting media item creators that their media item 121 has initiated or is part of a media trend, and/or providing creators with access to tools to enable the creators to control the use or distribution of their media item 121 in accordance with the media trend. As illustrated in FIG. 3, trend discovery module 216 can include a viewer discovery component 316 and/or a creator discovery component 318. As described herein, media item manager 132 can provide a user with access to media item 121 (e.g., upon receiving a request from a client device 102 of the user). In some embodiments, viewer discovery component 316 can detect that a media item 121 to be provided to a client device 102 is determined to be associated with a detected media trend, in accordance with previously described embodiments, and can provide a notification to the client device 102 (e.g., with the media item 121) indicating that the media item 121 is associated with the media trend. In some embodiments, viewer discover component 316 can also provide a user with an indication of one or more additional media items 121 associated with the media trend (e.g., in response to a request from the client device 102).

As described above, trend identification module 210 can identify one or more media items 121 that originated or created a media trend. In some embodiments, creator discovery component 318 can provide a notification to creators associated with the identified media item(s) 121 that their media item 121 is determined to have originated or created the media trend. For example, upon identification of the one or more media items 121, creator discovery component 318 can determine an identifier for a user and/or a client device 102 that provided the media item 121 and can transmit the notification to the client device 102 associated with the user. In some embodiments, the creator discovery component 318 can additionally or alternatively provide to the client device 102 one or more UI elements that enable the creator to control the user or distribution of their media item 121 in accordance with the media trend. For example, the one or more UI elements can enable the creator to prevent or limit notifying other users accessing the media item 121 that the media item 121 is associated with the media trend. In another example, the one or more UI elements can enable the creator to prevent or limit sharing of the media item 121 between other users of platform 120. In some embodiments, creator discovery component 318 can update media item data store 252 to indicate the preferences provided by the creator (e.g., based on user engagement with the one or more UI elements). Viewer discovery component 316 and/or media item manager 132 can provide access to the media item 121 and/or enable sharing of the media item 121 in accordance with the creator preferences, in some embodiments.

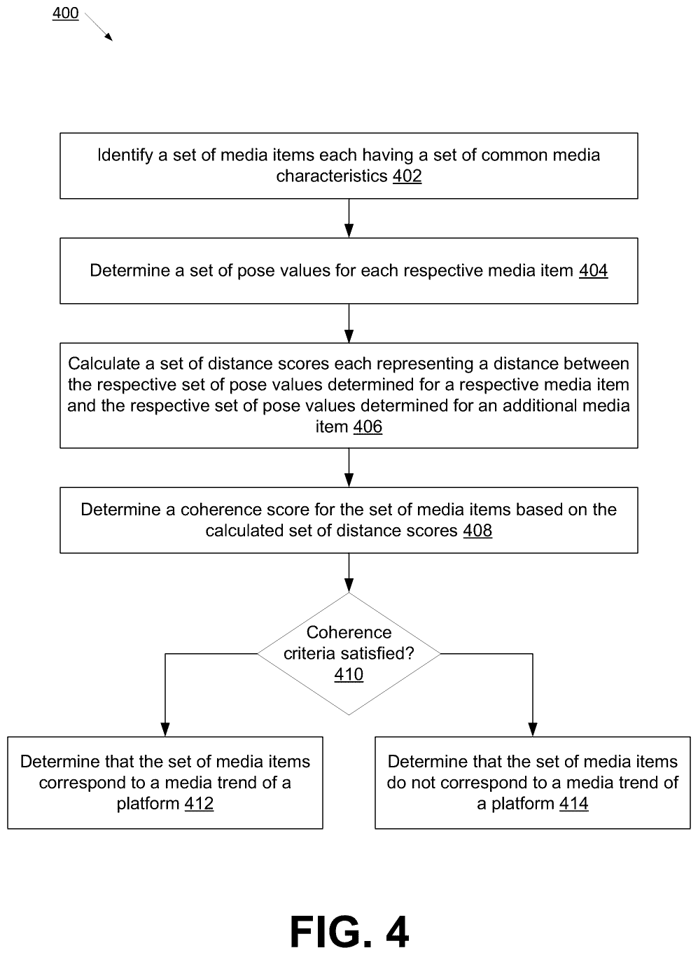

FIG. 4 is a block diagram of an example method 400 for media trend detection of content sharing platforms, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by trend engine 152. For example, some or all of operations of method 400 can be performed by one or more components of trend identification module 210 (e.g., embedding generator 310, trend candidate generator 312, and/or trend candidate selector 314) and/or trend maintenance module 212.

At block 402, processing logic identifies a set of media items each having a set of common media characteristic. In some embodiments, processing logic (e.g., trend candidate generator 312) can identify the set of media items from media item data store 252. The common media characteristics can include, for example, a common audio signal, common metadata (e.g., a common title, common keywords or hashtags, etc.), and/or common visual features. In some embodiments, trend candidate generator 312 can identify the set of media items upon determining that a number of media items 121 of platform 120 that share the common media characteristics exceeds a threshold number. In an illustrative example, users (e.g., creators) of platform 120 can upload media items 121 for sharing with other users, as described above. Upon receiving the uploaded media items 121, media item manager 132 can store the media items 121 at media item data store 252. In some embodiments, media item manager 132 can obtain or otherwise determine one or more media characteristics associated with the media items 121 (e.g., a song of the media items 121, a title of the media items 121, etc.) and can store the media characteristics with the media items 121 at media item data store 252. Trend candidate generator 312 can determine that a number of media items 121 sharing common media characteristics at data store 252 exceed the threshold number and can identify such media items 121 from data store 252, in some embodiments.

In other or similar embodiments, trend identification module 210 and/or trend maintenance module 212 can perform one or more operations of method 400 upon receiving a newly uploaded media item 121. For example, when a creator uploads a media item 121 for sharing via platform 120, trend identification module 210 and/or trend maintenance module 212 can perform one or more operations of method 400 with respect to the media item 121 (e.g., determining a set of pose values, calculating a set of distance scores with respect to other media items 121 of platform 120, calculating a coherence score, etc.). It should be noted that although some embodiments of the present disclosure describe the operations of method 400 being performed with respect to a set of media items sharing common media characteristics, such operations of method 400 can be performed with respect to any media item 121 (e.g., regardless of whether such media item 121 is determined to share common media characteristics with other media items 121).

At block 404, processing logic determines a set of pose values for each respective media item of the set of media items. Each pose value of a set of pose values determined for a respective media item 121 can be associated with a particular pose of a set of predefined poses for objects depicted by the set of media items 121, as described in further detail below. In some embodiments, trend candidate generator 312 can obtain a set of audiovisual embeddings for a respective media item 121 of the set of media items. An audiovisual embedding refers to a representation that combines both audiovisual data and visual data for a media item into a unified, lower dimensional space. In some embodiments, embedding generator 310 can generate the set of audiovisual embeddings for a media item 121 based on a set of video embeddings for the media item 121 and a set of audio embeddings for the media item 121.

Embedding generator 310 can obtain a set of video embeddings for a media item by providing one or more video frames of the media item 121 as an input to an image encoder. An image encoder refers to an AI model (or a component of an AI model) that transforms raw image data into a structured, high-dimensional representation (e.g., a feature vector) of features or information of the image. An image encoder can take an image, such as a video frame, as an input and can extract features from the input image by applying a series of filters to capture various aspects of the image, such as edges, textures, colors, patterns, and so forth. The filters applied to the input image and/or the aspects of the image captured by the image encoder may be defined and/or specified based on the training of the image encoder. In some embodiments, image encoder is employed using a deep learning approach, such as that of a convolutional neural network (CNN) architecture. In such embodiments, the image encoder can include or be made up of a network including multiple layers, such as a convolutional layer (e.g., which applies various filters to the image to create feature maps highlighting different features at various scales), an activation function layer (e.g., which introduces non-linearities into the network, allowing it to learn more complex patterns), a pooling layer (e.g., which reduces the dimensionality of the feature maps, which enable the representation to be abstract and invariant to small changes in the input image), and/or a normalization layer (e.g., which stabilize the learning process and improve the convergence of training of the image encoder). In some embodiments, an output of the image encoder can include a feature vector (or a set of feature vectors) that represent the content of the input image in a compressed and informative way. In some embodiments, the image encoder can include a vision transformer, a visual geometry group deep convolutional network (VGGNet) encoder, a residual network (ResNet) encoder, an inception encoder, an autoencoder, and so forth.

As indicated above, embedding generator 310 can provide one or more image frames of media item 121 as an input to an image encoder and can obtain the set of video embeddings based on one or more outputs of the image encoder. Each of the set of video embeddings can include or correspond to a frame token, which refers to a unit of processed information output by an image encoder. Each frame token can represent the features of one or more frames of the media item 121, in some embodiments.

Embedding generator 310 can obtain a set of audio embeddings 508 based on one or more outputs of an audio encoder. An audio encoder refers to an AI model or engine that converts an audio signal into a vector representation that captures the audio features of the input audio data. In some embodiments, audio encoder can include an audio spectrogram transformer, which processes audio data by converting it to a spectrogram (e.g., a visual or numerical representation of an audio signal's frequency spectrum over time) and uses a transformer architecture to extract meaningful features from the audio, such as the audio features described herein. Embedding generator 310 can provide audio data of media item 121 as an input to an audio encoder and can obtain the set of audio embeddings based on one or more outputs of the audio encoder. Each of the set of audio embeddings can correspond to a segment of audio for a frame.

In some embodiments, embedding generator 310 can provide the set of video embeddings and the set of audio embeddings as an input to a concatenation engine. A concatenation engine can perform one or more concatenation operations to concatenate each frame token of the set of video embeddings with a corresponding audio embedding of the set of audio embeddings. Based on the concatenation operations, embedding generator can generate the set of audiovisual embeddings. The set of audiovisual embeddings can include each frame token of the set of video embeddings concatenated with each corresponding audio embedding of the set of audio embeddings.

In some embodiments, embedding generator 310 can additionally or alternatively perform one or more attention pooling operations to the concatenated video and audio embeddings. An attention pooling operation refers to an operation that reduces the dimensionality of a feature map, which enables the output representation to be abstract and invariant to small changes. In some embodiments, the attention pooling operations can include a generative pooling operation and/or a contrastive pooling operation. In some embodiments, embedding generator 310 can provide the concatenated video and audio embeddings as an input to the one or more attention pooling operations and can obtain the set of audiovisual embeddings based on one or more outputs of the attention pooling operation(s).

In some embodiments, embedding generator 310 can generate a feature pyramid based on the set of audiovisual embeddings generated for a media item 121. A feature pyramid refers to a multi-scale representation of content associated with the audiovisual features of the audiovisual embeddings. A feature pyramid has a hierarchical structure where each level of the pyramid represents features at a different scale, with higher levels having coarser (e.g., lower resolution but semantically stronger) features and lower levels having finer (e.g., higher resolution but semantically weaker) features. In some embodiments, the highest level of the feature pyramid includes embeddings associated with an entire image (e.g., of an image frame) and/or large portions of the image, which provides the high-level semantic information pertaining to content of the image (e.g., the presence of an object). As indicated above, embeddings of the highest level have the lowest resolution but cover the largest field of view of the content. Intermediate levels of the feature pyramid progressively increase in resolution and decrease in field of view. The lowest level of the feature pyramid includes embeddings with the highest resolution, and depict small regions of the image to capture fine details of the overall image. In some embodiments, the feature pyramid can include or correspond to a Feature Pyramid Network (FPN), which includes connections between features from different scales.

Embedding generator 310 can generate the feature pyramid by performing one or more sampling operations with respect to the frame tokens output by the transformer encoder. The one or more sampling operations can include down sampling operations, which reduce the resolution of input frame tokens and/or upsampling operations, which increase the resolution of input frame tokens. In some embodiments, a down sampling operation can include or involve pooling or strided convolutions in a convolutional neural network to reduce dimensionality of the features associated with an input frame token. In additional or alternative embodiments, an upsampling operation can involve bilinear interpolation, transposed convolutions, and/or learnable upsampling to recover spatial resolution of the input frame token. In an illustrative example, the highest level of the feature pyramid can include the frame tokens output by the transformer encoder. Embedding generator 310 can perform one or more down sampling operations with respect to the frame tokens to generate one or more intermediate layers of the feature pyramid. To generate each lower level of the feature pyramid, embedding generator 310 may perform a down sampling operation with respect to the frame token of the level directly above the lower level.

In some embodiments, embedding generator 310 and/or trend candidate generator 312 can obtain one or more pose embeddings representing a pose of objects depicted by a media item based on the audiovisual embeddings described above. For example, as described above, lower levels of the feature pyramid (e.g., the lowest level, the second lowest level, etc.) can represent fine details of the overall image depicted by a video frame (or sequence of video frames). A video frame, as described herein, can include a pixel array composed of pixel intensity data associated with visual features of a media item 121. In some embodiments, such fine details can include a pose, an action, a motion, etc. of an object depicted by the video frame(s). In some embodiments, embedding generator 310 and/or trend candidate generator 312 can extract data from such feature pyramid that is specific to the pose of the object. Such data is referred to as a pose embedding, that indicates visual features of a pose of the object, as depicted by the corresponding video frame(s). In some embodiments, data of the pose embedding can be view invariant, meaning that the pose embedding can include data indicating a pose of the object according to the view point depicted in the video frame(s) and/or other view points of the object. In an illustrative example, a media item 121 can depict actions or motions of a dancer that is facing a camera. The pose embedding for the media item 121 can include data indicating the poses of the dancer according to the view point depicted in the video frame(s) (e.g., of the dancer facing the camera) and also, in some embodiments, poses of the dancer according to a different view point (e.g., behind the dancer, from one or more sides of the dancer, etc.).

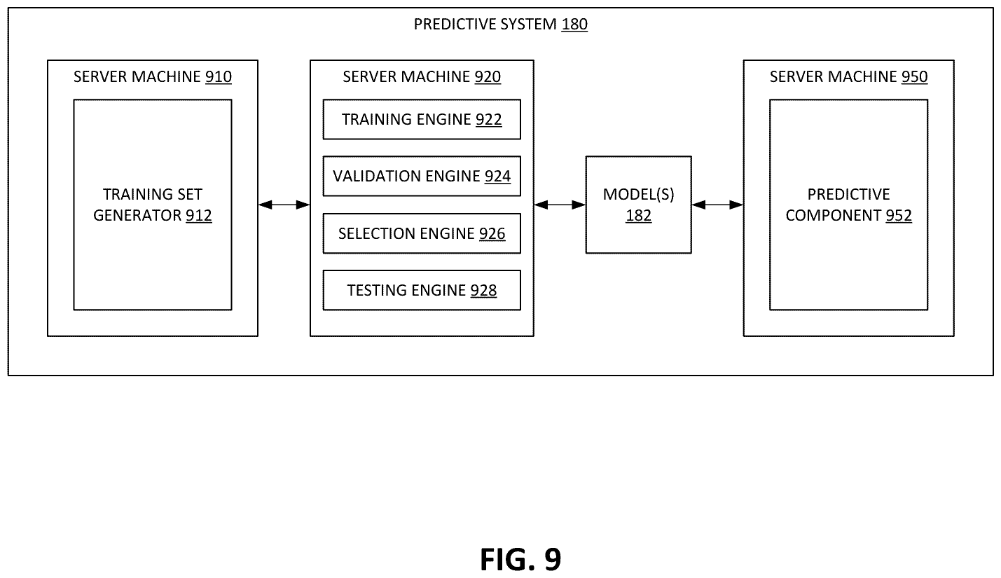

In additional or alternative embodiments, trend candidate generator 312 can obtain the pose embeddings for a media item 121 according to other techniques. For example, rather than (or in addition to) obtaining audiovisual embeddings for a media item 121, as described above, embedding generator can provide one or more video frames of the media item 121 as an input to fine-grained video embedding model, which is trained to generate fine-grained embeddings based on a given sequence of video frames. A fine-grained video embedding refers to an embedding that represents fine-grained features of an image (e.g., a pose, an action, a motion, etc. of an object depicted by the image). In some embodiments, the fine-grained video embedding model can be trained to generate a set of pose embeddings for objects detected in video frames of a media item 121. Further details regarding training the fine-grained video embedding model are provided with respect to FIG. 9 below. In some embodiments, trend candidate generator 312 and/or embedding generator 310 can provide video frames for a media item 121 as an input to the fine-grained video embedding model and can extract a set of pose embeddings for the media item 121 from one or more outputs of the fine-grained embedding model. In some embodiments, one or more of the set of pose embeddings can be view invariant, as described above.

Upon obtaining the set of pose embeddings for each of the media items 121 identified with respect to block 402, trend candidate generator 312 can determine a set of pose values for each respective media item 121 based on the obtained pose embeddings. As indicated above, a pose value can be associated with a predefined pose for an object depicted by the media items 121. In some embodiments, a developer or operator of platform 120 can provide trend candidate generator 312 with a data structure (e.g., a table, a list, etc.) that includes one or more entries each corresponding to a respective pose for objects having an object type that is the same or similar to the object depicted by the media items 121. Each entry can include an indication of one or more visual features that define or otherwise contribute to the respective pose and an indication of a pose value assigned for the respective pose (e.g., by the developer or the operator, by another entity or system, etc.). In an illustrative example, the data structure can include entries corresponding to respective poses for dancers. Each entry of the data structure can include visual features that define or otherwise contribute to a respective dance pose and can indicate a pose value assigned for the respective dance pose. Trend candidate generator 312 can compare the visual features indicated by the pose embeddings for a respective media item 121 with the visual features identified by entries of the data structure and, upon determining that the visual features match (or approximately match), trend candidate generator 312 can extract the pose value for the respective pose having the matching visual features from the corresponding entry of the data structure. Trend candidate generator 312 can update a set of pose values for the media item 121 to include the extracted pose value, in some embodiments.

It should be noted that the term “pose values” is provided merely for purposes of explanation and illustration. Any type of identifier or metric can be used to indicate a respective pose of an object, in accordance with embodiments of the present disclosure.

At block 406, processing logic calculates a set of distance scores each representing a distance between the respective set of pose values determined for a respective media item and the respective set of pose values determined for an additional media item of the set of media items. A distance score refers to a metric that indicates how similar or different data points are from one another. In some embodiments, trend candidate generator 312 calculates a distance score representing a distance between the pose values determined for a respective media item 121 of the set of media items and an additional media item 121 of the set of media items. The determined distance score can be represented as a Jaccard distance value and/or a Jaccard similarity value. A Jaccard distance value may represent a measure of how dissimilar two sets of data are, and a Jaccard similarity value may represent a measure of how similar two sets of data are. In some embodiments, a Jaccard distance value and/or a Jaccard similarity value can be derived based on a Jaccard Index value, which quantifies the similarity between two sets of data as a ratio of a size of their intersection to a size of their union. A Jaccard Index value can range between 0 and 1, where a value of 0 indicates no similarity (e.g., no shared elements between the datasets) and a value of 1 indicates that the sets are identical (e.g., complete overlapping of elements between the datasets). In some instances, the Jaccard similarity value can be represented by the Jaccard Index value, while the Jaccard distance value can be represented by the complement of the Jaccard Index value.

It should be noted that the distance score can be calculated and/or represented according to additional or different techniques. For example, the distance score for two or more sets of pose values can be represented by or correspond to a Euclidean distance value, a Manhattan distance value, a cosine similarity value, a Minkowski distance value, and so forth.

In some embodiments, trend candidate generator 312 can calculate the set of distance scores for each media item 121 of the set of media items 121 relative to each additional media item 121 of the set of media items 121. In an illustrative example, the set of media items 121 can include three media items, e.g., media item A, media item B, and media item C. Trend candidate generator can determine a first distance score based on the sets of pose values for media items A and B, a second distance score based on the sets of pose values for media items A and C, and a third distance score based on the sets of pose values for media items B and C. Accordingly, the set of distance scores can include each of the first distance score, the second distance score.

At block 408, processing logic (e.g., trend candidate generator 312 and/or trend candidate selector 314) determines a coherence score for the set of media items based on the calculated set of distance scores. As indicated above, a coherence score can indicate a size of a data cluster including each of the set of media items (e.g., in view of the calculated distance scores) and/or a degree of similarity of a creation history between each of the set of media items. A creation history can include or indicate one or more other media items 121 that inspired the creation of a media item 121 of the set of media items 121. In some instances, the other media item 121 can be included in the set of media items 121 and/or can be outside of the set of media items 121. In some embodiments, trend candidate selector 314 can determine an aggregate distance distribution for the set of media items 121 based on each of the set of distance scores calculated for the set of media items 121. The aggregate distance distribution can reflect a size of a data cluster that includes each of the set of media items 121, in some embodiments, where a small aggregate distance distribution reflects a small data cluster including the media items 121 (e.g., indicating that the visual features of the media items 121 are the same or very similar) and a large aggregate distance distribution reflects a large data cluster including the media items 121 (e.g., indicating that the visual features of the media items 121 are different). In an illustrative example, trend candidate selector 314 can determine the aggregate distance distribution for the set of media items 121 by determining an aggregate value (e.g., an average value, a median value, etc.) for each of the set of distance scores determined for the media items 121.

In some embodiments, trend candidate selector 314 can determine a creation history for each of the set of media items 121 based on metadata for such media items 121 (e.g., stored at media item data store 252). In some embodiments, metadata for a media item 121 can include or otherwise indicate a media item 121 that inspired a user of platform 120 to create the media item 121, as described above. Trend candidate selector 314 can identify an inspiration media item 121 for one or more of the set of media items 121 and determine a degree of similarity of the creation history for each of the set of media items 121 based on the identified inspiration media items 121. For example, trend candidate selector 314 can determine that the creation history for the set of media items 121 is associated with a high degree of similarity upon determining that a threshold number of media items 121 of the set are associated with a common inspiration media item 121. In another example, trend candidate selector 314 can determine that the creation history for the set of media items 121 is associated with a low degree of similarity upon determining that the number of media items 121 associated with the common inspiration media item 121 fall below the threshold number.

As indicated above, trend candidate selector 314 can determine a coherence score for the set of media items 121 based on the size of the data cluster associated with the set of data items 121 and/or the degree of similarity of the creation history for the set of media items 121. In an illustrative example, trend candidate selector 314 can determine that the set of media items 121 is associated with a large coherence score upon determining that the size of the data cluster is small and/or the degree of similarity of the creation history for the set of media items 121 is large. In another illustrative example, trend candidate selector 314 can determine that the set of media items 121 is associated with a low coherence score upon determining that the size of the data cluster is large and/or the degree of similarity of the creation history for the set of media items 121 is small.

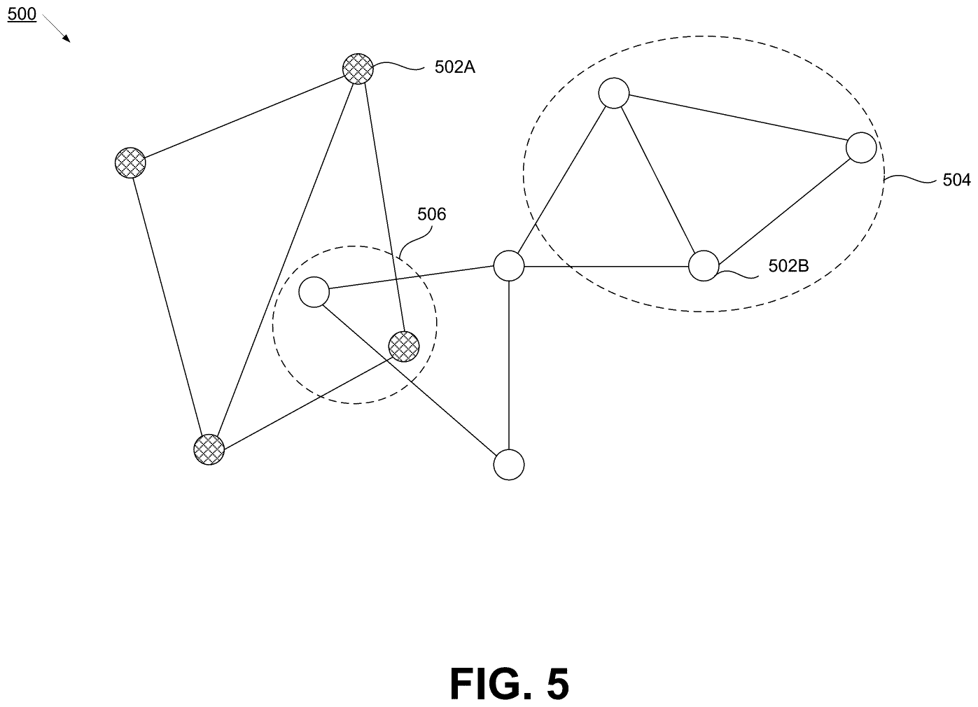

FIG. 5 illustrates an example of determining a coherence between media items of a platform, in accordance with implementations of the present disclosure. FIG. 5 depicts a cluster representation 500 of data points 502 representing one or media items 121 of a set of media items. In some embodiments, data points 502A can represent pose values determined for each of a set of media items associated with a first common media characteristic (e.g., a common audio signal) and data points 502B can represent pose values determined for each of a set of media items associated with a second common media characteristic. In accordance with previously described embodiments, trend candidate selector 314 can determine a high coherence score for media items 121 included in cluster 504 upon determining that the size of the cluster 504 falls below a threshold cluster size and/or the creation history of each of the data points 502B is associated with a high degree of similarity.

In some embodiments, processing logic (e.g., trend candidate generator 312, trend candidate selector 314) can determine set of distance scores and/or the coherence score for the set of media items according to AI techniques, in some embodiments. In an illustrative example, processing logic can obtain the embeddings (e.g., audiovisual embeddings, pose embeddings, etc.) for each of the set of media items 121 and can provide the obtained embeddings as an input to one or more AI models that are trained to predict a coherence score based on given embeddings for a set of media items 121. In some embodiments, the AI model(s) can be or can be components of trend detection model 184 and/or trend maintenance model 186. In other or similar embodiments, the AI model(s) can be different from trend detection model 184 and/or trend maintenance model 186. The AI models may calculate or otherwise predict the pose values for the media items based on the given embeddings and/or may calculate the set of distance scores based on the determined pose values, in some embodiments. In additional or alternative embodiments, the AI model(s) may perform one or more clustering operations to identify clusters of the media items 121 based on the given embeddings. The clusters may be identified based on a distance between the poses between two or more media items 121 of the set of media items (e.g., in view of the pose values associated with such media items 121). The one or more clustering operations may involve identifying clusters by minimizing the distance between data points (e.g., pose values) within the same cluster while maximizing the distance from other data points in other clusters. The one or more clustering operations can include, but are not limited to, K-Means clustering operations, hierarchical clustering operations, DBSCAN clustering operations, Gaussian Mixture Models (GMM) clustering operations, and so forth.

In some embodiments, the AI model(s) may provide one or more outputs including an indication of the set of distance scores predicted for the set of media items 121 based on the given embeddings. In other or similar embodiments, the AI model(s) may provide one or more outputs that additionally or alternatively include a predicted coherence score for the set of media items 121 in view of the predicted set of distance scores and/or creation history metadata for the media items 121 (e.g., obtained from media item data structure 252). Trend candidate selector 314 can extract the set of distance scores and/or the coherence score from the one or more outputs of the AI model(s) and can determine whether the media items 121 correspond to a media trend based on the extracted set of distance scores and/or coherence score, in accordance with embodiments described herein.

Referring back to FIG. 5, one or more outputs of the AI model(s) can indicate that media items 121 indicated by data points of cluster 504 are associated with a high coherence score (e.g., based on the one or more clustering operations performed by the AI model(s) and/or in view of the creation history for the media items 121 included in cluster 504, in an illustrative example. In another illustrative example, the one or more outputs of AI model(s) can indicate that media items 121 indicated by data points of cluster 506 are associated with a low coherence score (e.g., based on the one or more clustering operations performed by the AI model(s)). As illustrated by FIG. 5, a size of cluster 506 may fall below the cluster size threshold, but a creation history of media items 121 of such cluster 506 may not have a high degree of similarity (e.g., as cluster 506 includes data points for media items 121 having different media characteristics).

Referring R back to FIG. 4, at block 410, processing logic determines whether the determined coherence score satisfies one or more coherence criteria. In some embodiments, a determined coherence score can satisfy one or more coherence criteria upon a determination that the coherence score exceeds a threshold coherence score. In other or similar embodiments, a determined coherence score can satisfy the one or more coherence criteria upon a determination that the coherence score is larger than the coherence score for other data clusters corresponding to other media items 121 (e.g., identified according to clustering operations of the AI model(s)). Responsive to a determination that the determined coherence score satisfies the one or more coherence criteria, method 400 proceeds to block 412. At block 412, processing logic determines that the set of media items correspond to a media trend of a platform. In some embodiments, trend candidate selector 314 can update media item data store 252 to indicate that each of the set of media items 121 are associated with the media trend. In additional or alternative embodiments, trend candidate selector 314 can identify one or more of the set of media items 121 that best represent the media trend and can extract trend template data from the embeddings associated with the identified media item(s) 121, as described herein. Responsive to a determination that the calculated coherence score does not satisfy the one or more coherence criteria, method 400 proceeds to block 414. At block 414, processing logic determines that the set of media items do not correspond to a media trend of a platform.

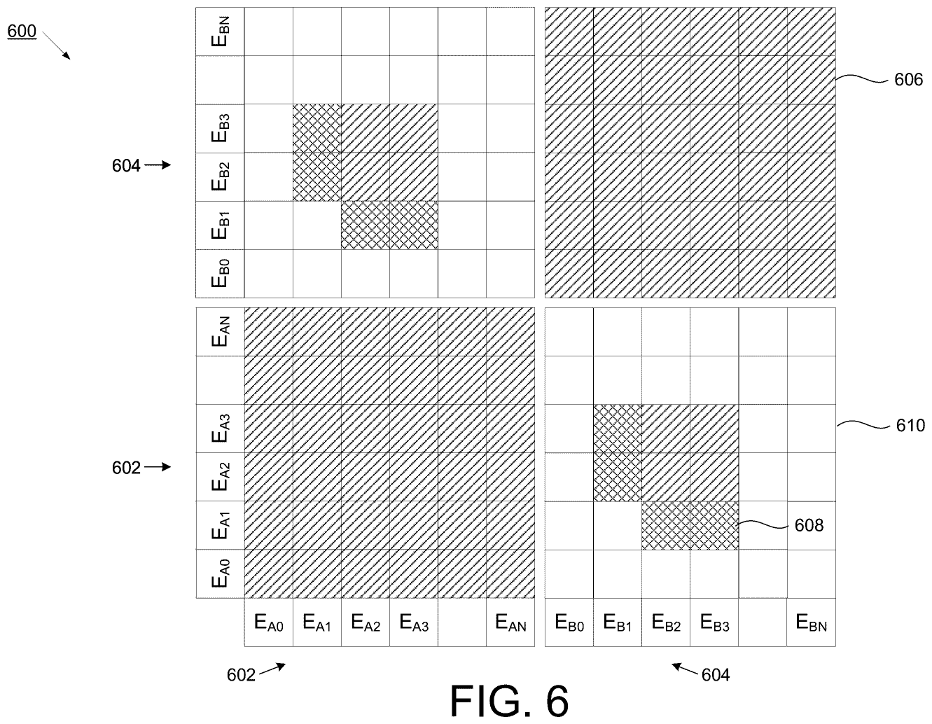

As described above, processing logic can calculate a distance score for two or more media items 121 by determining a distance (e.g., a Jaccard distance) between pose values determined for such media items 121, in some embodiments. In additional or alternative embodiments, processing logic can calculate the distance score by determining a degree of alignment between fine-grained video embeddings (e.g., pose embeddings, etc.) obtained for the media items. FIG. 6 depicts an example of comparing media item embeddings for media item characterization, in accordance with implementations of the present disclosure. In some embodiments, processing logic can obtain the fine-grained video embeddings according to embodiments described herein (e.g., embodiments described with respect to block 404 above). In some embodiments, processing logic can perform one or more comparison operations to compare the features indicated by the fine-grained embeddings for the media item 121 to the fine-grained embeddings for the additional media item 121. An output of the comparison operations can indicate to processing logic a degree of alignment between the visual features of the object depicted by the media item 121 and the visual features of the additional object depicted by the additional media item 121. In some embodiments, the one or more comparison operations can include a dynamic time warping operation. A dynamic time warping operation refers to an operation or set of operations that measure the similarity between two temporal sequences that may vary in speed or time. In some embodiments, the dynamic time warping operation can be performed by one or more AI models, as described below.

FIG. 6 depicts a graphical representation 600 of the similarities between fine-grained video embeddings 602 for a first media item 121 and fine-grained video embeddings 604 for a second media item 121. Referring to FIG. 6, each segment (e.g., block) of the graphical representation 600 can indicate a degree of alignment between a respective fine-grained embedding on the x-axis of the graphical representation 600 and a respective fine-grained embedding on the y-axis of the graphical representation 600. A degree of alignment between respective embeddings refers to a distance or difference between visual features (e.g., poses, actions, motions) represented by such embeddings. As illustrated in FIG. 6, the degree of alignment between two embeddings such embeddings is indicated by a distinct pattern. For example, embeddings that share a high degree of alignment (e.g., exceeding a first threshold degree of alignment) are indicated by a first pattern 606, embeddings that share a medium degree of alignment (e.g., falling between the first threshold degree of alignment and a second threshold degree of alignment) are indicated by a second patter 608), and embeddings that share a low degree of alignment (e.g., falling below the second threshold degree of alignment are indicated by a third pattern 610 (e.g., or no pattern). As illustrated in FIG. 6, blocks representing the alignment between embeddings 602 on the x-axis and embeddings 602 on the y-axis share a high degree of alignment (e.g., as indicated by the first pattern 606). Similarly, blocks representing the alignment between embeddings 604 on the x-axis and embeddings 604 on the y-axis also share a high degree of alignment.

In some embodiments, processing logic can perform one or more comparison operations to determine the degree of alignment between each of the first embeddings 602 and the second embeddings 604. An output of the one or more comparison operations can include information or data represented by graphical representation 600, in some embodiments. In some embodiments, the one or more comparison operations can involve providing first embeddings 602 and the second embeddings 604 as an input to an AI model that is trained to predict the degree of alignment between given sets of embeddings. In some embodiments, the AI model can be or can be a component of trend detection model 184 and/or trend maintenance model 186. In other or similar embodiments, the AI model can be a different AI model from trend detection model 184 and/or trend maintenance model 186. The AI model can determine the degree of alignment for each of the first embeddings 602 and the second embeddings 604, in accordance with the comparison depicted by FIG. 6 and can determine an aggregate degree of alignment between the first embeddings 602 and the second embeddings 604. The aggregate degree of alignment can be a value (e.g., a score, etc.) indicating the degree of alignment between the media items 121 associated with the first embeddings 602 and the second embeddings 604. In an illustrative example, a high value can indicate a high degree of alignment (e.g., that the content of the media items 121 are matching or approximately matching) and a low value can indicate a low degree of alignment (e.g., that the content of the media items do not match). Upon determining that the value indicated by the one or more outputs of the AI model exceeds a threshold value, processing logic can determine that the alignment criteria are satisfied. Such determined value or score can correspond to a distance score described with respect to block 406 of method 400.

In some embodiments, some embeddings of the first embeddings 602 can share a high degree of alignment with embeddings of the second embeddings 604, while others do not. For example, as illustrated by FIG. 6, processing logic can determine that embeddings E_{A2} and E_{A3} share a high degree of alignment with embeddings E_{B2} and E_{B3}, while other embeddings do not share a high degree of alignment. This can indicate that one or more poses or motions represented by embeddings E_{A2} and E_{A3} are the same as or similar to poses or motions represented by embeddings E_{B2} and E_{B3}. In some embodiments, one or more outputs of the comparison operations can indicate the embeddings of embeddings 602 and embeddings 604 that share the high degree of alignment. Processing logic may determine that the alignment criteria are satisfied with respect to such embeddings, in accordance with previously described embodiments.

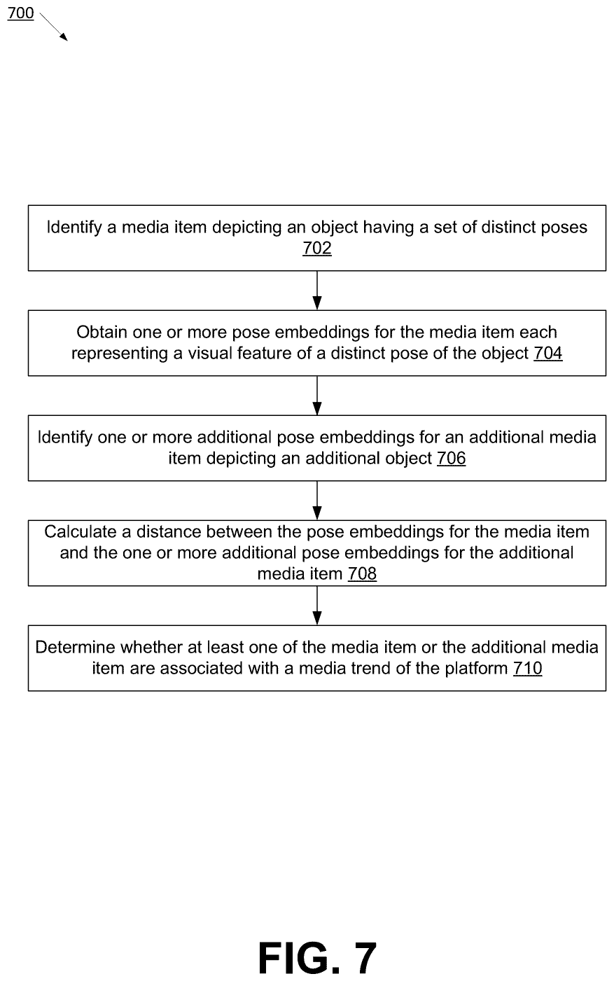

FIG. 7 is a block diagram of another example method 700 for media trend detection of content sharing platforms, in accordance with implementations of the present disclosure. Method 700 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1. In some embodiments, some or all of the operations of method 700 can be performed by trend engine 152. For example, some or all of operations of method 700 can be performed by one or more components of trend identification module 210 (e.g., embedding generator 310, trend candidate generator 312, and/or trend candidate selector 314) and/or trend maintenance module 212.

At block 702, processing logic identifies a media item depicting an object having a set of distinct poses. In some embodiments, processing logic (e.g., trend identification module 210) can identify the media item 121 from media item data store 252. In other or similar embodiments, media item manager 132 can receive the media item 121 from a client device 102 associated with a user (e.g., a creator) of platform 120. Media item manager 132 can provide the media item 121 to trend identification module 210 upon receiving the media item 121. In accordance with embodiments and examples provided herein, the media item 121 described with respect to method 700 may be a “newly uploaded” media item 121 to platform 120. However, it should be noted that such embodiments and examples can be applied to any media item 121 of platform 120. In some embodiments, media item 121 can include a sequence of video frames depicting an object having a set of distinct poses. In an illustrative example, media item 121 may depict one or more performers dancing to a particular song.

At block 704, processing logic obtains one or more pose embeddings for the media item each representing a visual feature of a distinct pose of the object. Trend identification module 210 can obtain the one or more pose embeddings in accordance with embodiments described herein. For example, embedding generator 310 can generate a set of audiovisual embeddings for the media item 121 and can extract one or more pose embeddings from the generated set of audiovisual embeddings, as described above. In other or similar embodiments, embedding generator 310 can provide one or more video frames of media item 121 as an input to a fine-grained embedding model and can extract the one or more pose embeddings from an output of the fine-grained embedding model. It should be noted that although some embodiments and examples are described with respect to pose embeddings, embodiments and examples can be applied to any type of fine-grained video embedding, as described herein.

At block 706, processing logic identifies one or more additional pose embeddings for an additional media item depicting an additional object. In some embodiments, the additional media item 121 may be determined to be associated with a media trend of platform 120, as described above. In other or similar embodiments, trend candidate generator 312 and/or trend candidate selector 314 may have determined that the additional media item 121 is not associated with a media trend of platform 120 (e.g., in accordance with embodiments described with respect to FIG. 4). In yet other or similar embodiments, additional media item 121 may be recently received by platform 120 from a client device 102 associated with a user of platform 120 (e.g., before or after receipt of media item 121). Trend maintenance module 212 can identify the one or more additional pose embeddings for the additional media item 121 in accordance with previously described embodiments. For example, embedding generator 310 can generate or obtain the pose embeddings as described above. In other or similar embodiments, trend identification module 210 and/or another module or component of trend engine 152 can determine that the additional media item 121 satisfies one or more template criteria, as described herein. Trend maintenance module 212 can identify the one or more pose embeddings for the additional media item 121 from trend template data 256, as described herein.

At block 708, processing logic calculates a distance between the pose embeddings for the media item and the one or more additional pose embeddings for the additional media item. In some embodiments, trend maintenance module 214 can calculate the distance between pose embeddings for the media item 121 and the pose embeddings for the additional media item 121 in accordance with embodiments described with respect to FIGS. 4-6. For example, trend maintenance module 214 can determine a set of pose values for each media item 121 based on the obtained pose embeddings and can calculate a distance score representing the distance between the sets of pose values, as described above. In other or similar embodiments, trend maintenance module 214 can provide the pose embeddings and/or the sets of pose values for the media items 121 as an input to an AI model (e.g., trend maintenance model 186) that is trained to predict a distance or degree of difference between two or more media item 121. Trend maintenance module 214 can extract a value indicating the distance between the pose embeddings for the media items 121 from one or more outputs of the AI model, as described herein. In yet other or similar embodiments, trend maintenance module 214 can determine a degree of alignment between the media items 121, in accordance with embodiments described with respect to FIG. 6, where the determined degree of alignment indicates the distance between the pose embeddings.

It should be noted that although some embodiments of the present disclosure (e.g., with respect to FIG. 7 and elsewhere) may describe a component or module of trend engine 152 determining the degree of alignment for two or more media items 121, one or more AI models 182 described herein (e.g., trend detection model 184, trend maintenance model 186, etc.) can apply one or more techniques described with respect to FIG. 6 to determine the degree of alignment and/or determine a distance between features of two or more media items 121, as described herein.

At block 710, processing logic determines whether at least one of the media item or the additional media item are associated with a media trend of the platform. In some embodiments, trend maintenance module 212 can determine that the media item 121 shares the same or common audiovisual features with the additional media item 121 by determining that the calculated distance of block 708 falls below a threshold value. As described above, the additional media item 121 may be determined to be associated with a detected media trend of platform 120, in some embodiments. In such embodiments, trend maintenance module 212 can determine that the media item 121 also is associated with the detected media trend. In other or similar embodiments, additional media item 121 may have been previously determined to not be associated with a media trend. Upon determining (e.g., by trend identification module 210) that media item 121 is associated with the media trend, trend maintenance module 212 can determine that the additional media item 121 is also associated with the detected media trend. In yet other or similar embodiments, trend maintenance module 212 and/or trend identification module 210 can determine that both media items 121 are associated with a media trend (e.g., an emerging media trend) upon determining that a coherence score determined for a set of media items including such media items 121 satisfy the one or more coherence criteria, as described above. Upon determining that the media item 121 and/or the additional media item 121 is associated with a media trend (e.g., according to any embodiment or example described herein), trend maintenance module 214 can update media item data store 252 to indicate that such media items 121 are associated with the media trends.

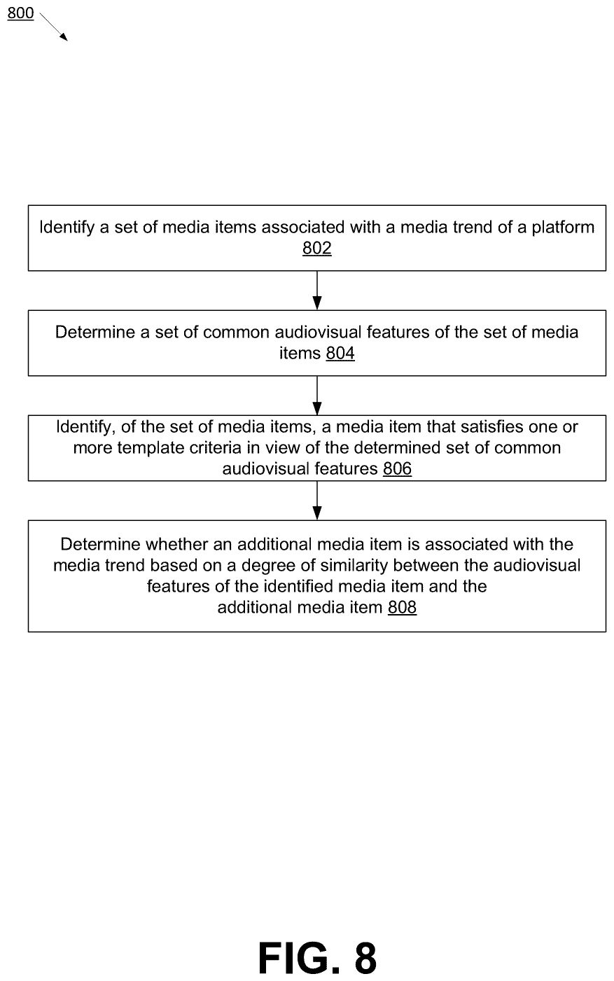

FIG. 8 is a block diagram of an example method for media trend maintenance, in accordance with implementations of the present disclosure. Method 800 can be performed by processing logic that can include hardware (circuitry, dedicated logic, etc.), software (e.g., instructions run on a processing device), or a combination thereof. In one implementation, some or all the operations of method 800 can be performed by one or more components of system 100 of FIG. 1. In some embodiments, some or all of the operations of method 800 can be performed by trend engine 152. For example, some or all of operations of method 800 can be performed by one or more components of trend identification module 210 (e.g., embedding generator 310, trend candidate generator 312, and/or trend candidate selector 314) and/or trend maintenance module 212.

At block 802, processing logic identifies a set of media items associated with a media trend of a platform. In some embodiments, the set of media items 121 can include the set of media items 121 described with respect to FIGS. 4-6. In other or similar embodiments, the set of media items 121 can include any media items 121 determined to be associated with a detected media trend and/or to share common media characteristics with media items 121 determined to be associated with a detected media trend.

At block 804, processing logic determines a set of common audiovisual features of the set of media items. In some embodiments, trend identification module 210 and/or trend maintenance module 212 can obtain one or more embeddings (e.g., audiovisual embeddings, fine-grained video embeddings, etc.) associated with the set of media items 121. Embedding generator 310 can generate the one or more embeddings for the set of media items 121 in accordance with previously described embodiments. In some embodiments, trend identification module 210 and/or trend maintenance module 212 can obtain the one or more embeddings from media item data store 252 and/or trend template data 256.

Processing logic can parse the embeddings obtained for the set of media items 121 and determine one or more embeddings that are common to each of the set of media items 121 in some embodiments. Processing logic can determine that an embedding is common to each of the set of media items 121 if such embedding (or a similar embedding) is included in the set of embeddings generated for each respective media item 121. As the set of media items 121 are identified as being associated with the media trend, such embedding may represent audiovisual features that are common to all media items 121 including content that correspond to the format or concept of the media trend. In some embodiments, processing logic can identify one or more embeddings that are common to teach of the set of media items 121 and can extract one or more audiovisual features from each of the identified embeddings. Processing logic can update the set of common audiovisual features to include the extracted one or more audiovisual features, in some embodiments.

At block 806, processing logic identifies, of the set of media items, a media item that satisfies one or more template criteria in view of the determined set of common audiovisual features. A media item 121 can satisfy the one or more template criteria if the audiovisual features of such media item 121 most closely matches the audiovisual features of the set of common audiovisual features. As described above, the embeddings for each of the set of media items 121 associated with the media trend may be similar, but may not perfectly match each other (e.g., due to different visual or audio phenomena introduced during the generation or creation of the media item). Upon determining the set of common audiovisual features of the set of media items, processing logic can identify, of the set of media items 121, the media item 121 having audiovisual features that most closely matches the common audiovisual features. A media item can most closely match the common audiovisual features if the media item shares a larger number of audiovisual features with the set of common audiovisual features than other media items of the set of media items 121, in some embodiments. In other or similar embodiments, the media item can most closely match the common audiovisual features if a distance between the audiovisual features of the media item 121 and the set of common audiovisual features is the smallest among each of the set of media items 121. Upon determining that audiovisual features of a particular media item 121 most closely matches the audiovisual features of the set of common audiovisual features, processing logic can determine that the media item 121 satisfies the one or more template criteria.

In some embodiments, processing logic can identify a media item that satisfies the one or more template criteria using one or more Al techniques. For example, processing logic can provide the embeddings for each of the set of media items 121 and/or the determined set of common audiovisual features as an input to one or more AI models (e.g., trend detection model 184, trend maintenance model 186, another AI model, etc.). Such AI models may be trained to predict a distance between embeddings of one or more media items and given audiovisual features. In some embodiments, processing logic can obtain one or more outputs of the AI model(s) and can determine, based on the one or more outputs, a media item 121 of the set of media items that has a smallest distance between embeddings for the media item 121 and the determined set of common audiovisual features. Processing logic can determine that such media item 121 satisfies the one or more template criteria, as described above.

In some embodiments, upon identifying a media item 121 that satisfies the one or more template criteria, processing logic can designate such media item 121 as a template that represents the format or concept of the media trend. Processing logic can store one or more embeddings for the media item 121 at memory 250 as trend template data 256. As described herein, such embeddings may be used to determine whether other media items 121 (e.g., newly uploaded media items 121) also correspond to the media trend.

At block 808, processing logic determines whether an additional media item is associated with the media trend based on a degree of similarity between audiovisual features of the identified media item and the additional media item. In some embodiments, media item manager 132 can receive a newly uploaded media item 121 to platform 120. Trend maintenance module 212 can obtain a set of audiovisual embeddings for the newly uploaded media item 121, as described above, and can determine a degree of similarity between the features indicated by the set of audiovisual embeddings and features of the embeddings associated with the media item 121 designated as the template for the media trend. Upon determining that a degree of similarity exceeds a threshold degree of similarity (e.g., and/or a distance between the features falls below a threshold distance), trend maintenance module 212 can determine that the newly uploaded media item 121 is also associated with the media trend.

FIG. 9 is a block diagram of an illustrative predictive system 180, in accordance with implementations of the present disclosure. As illustrated in FIG. 6, predictive system 180 can include a training set generator 912 (e.g., residing at server machine 910), a training engine 912, a validation engine 924, a selection 926, and/or a testing engine 928 (e.g., each residing at server machine 920), and/or a predictive component 952 (e.g., residing at server machine 950). Training set generator 912 may be capable of generating training data (e.g., a set of training inputs and a set of target outputs) to train AI model 182. Model 182 can include trend detection model 184 and/or trend maintenance model 186, as described above.

In some embodiments, trend detection model 184 can be an unsupervised machine learning model that performs one or more operations to identify relationships, clusters, and/or distributions between features (e.g., audiovisual features, textual features, etc.) indicated by given embeddings. The one or more operations can include k-means clustering operations, density-based spatial clustering of applications with noise (DBSCAN) operations, principal component analysis (PCA) operations, autoencoder operations, gaussian mixture models (GMM) operations, and so forth. Training set generator 912 can generate training data for trend detection model 184 by obtaining audiovisual embeddings and/or textual embeddings for media items 121 previously uploaded to platform 120. Such media items 121 may be associated with media trends (e.g., as specified by a developer or engineer of platform 120) or may not be associated with a media trend. Such training data can include the obtained audiovisual embeddings and/or the textual embeddings, in some embodiments.

In some embodiments, trend maintenance model 186 can be a supervised machine learning model. Training set generator 912 can generate training data for trend maintenance model 186 by identifying a media item 121 associated with a media trend (e.g., as specified by a developer or engineer of platform 120) and obtaining audiovisual embeddings and/or textual embeddings associated with such media item 121. In some embodiments, training set generator 912 can identify an additional media item 121 that is associated with the media trend and can obtain audiovisual embeddings and/or textual embeddings associated with the additional media item 121. In such embodiments, training set generator 912 can generate a training input including the audiovisual embeddings and the textual embeddings for the media items 121 and a target output indicating that both media items 121 are associated with the media trend. In other or similar embodiments, training set generator 912 can identify an additional media item 121 that is not associated with the media trend and can obtain audiovisual and/or textual embeddings associated with the additional media items 121. The training input can include the audiovisual embeddings and textual embeddings for the media items 121 and the target output can indicate that the additional media item 121 is not associated with the media trend. In each of the above embodiments, training set generator 912 can update the training data set for trend maintenance model 186 to include the training input and the target output.

Training engine 922 can train an AI model 182 using the training data from training set generator 912. The machine learning model 182 can refer to the model artifact that is created by the training engine 922 using the training data that includes training inputs and/or corresponding target outputs (correct answers for respective training inputs). The training engine 922 can find patterns in the training data that map the training input to the target output (the answer to be predicted), and provide the machine learning model 182 that captures these patterns. The machine learning model 182 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

Validation engine 924 may be capable of validating a trained machine learning model 182 using a corresponding set of features of a validation set from training set generator 912. The validation engine 924 may determine an accuracy of each of the trained machine learning models 182 based on the corresponding sets of features of the validation set. The validation engine 924 may discard a trained machine learning model 182 that has an accuracy that does not meet a threshold accuracy. In some embodiments, the selection engine 926 may be capable of selecting a trained machine learning model 182 that has an accuracy that meets a threshold accuracy. In some embodiments, the selection engine 926 may be capable of selecting the trained machine learning model 182 that has the highest accuracy of the trained machine learning models 182.

The testing engine 986 may be capable of testing a trained machine learning model 182 using a corresponding set of features of a testing set from training set generator 912. For example, a first trained machine learning model 182 that was trained using a first set of features of the training set may be tested using the first set of features of the testing set. The testing engine 928 may determine a trained machine learning model 182 that has the highest accuracy of all of the trained machine learning models based on the testing sets.

As described above, predictive component 952 of server 950 may be configured to feed data as input to model 182 and obtain one or more outputs. In some embodiments, predictive component 952 can include or be associated with trend candidate generator 312 and/or trend maintenance model 212. In such embodiments, predictive component 952 can feed audiovisual embeddings and/or textual embeddings obtained for media items 121 of platform 120 as an input to model 182, in accordance with previously described embodiments.

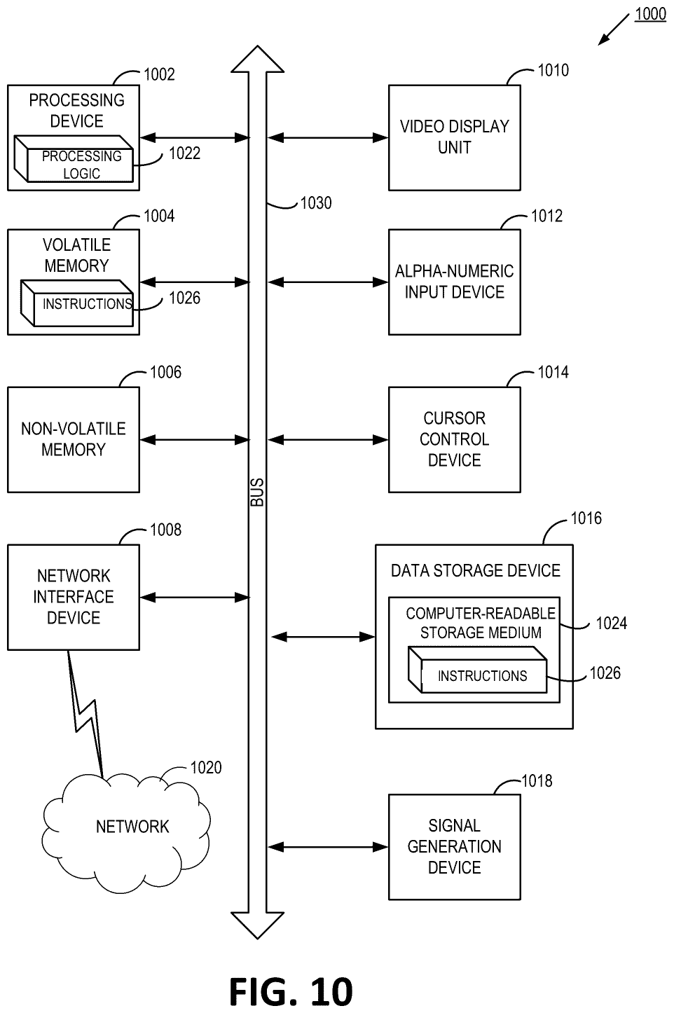

FIG. 10 is a block diagram illustrating an exemplary computer system 1000, in accordance with implementations of the present disclosure. The computer system 1000 can correspond to platform 120 and/or client devices 102A-N, described with respect to FIG. 1. Computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for providing fine-grained version histories of electronic documents at a platform. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying a plurality of media items each having a set of common media characteristics;
determining a set of pose values for each respective media item of the plurality of media items, wherein each pose value of a respective set of pose values determined for the respective media item is associated with a particular pose of a plurality of predefined poses for objects depicted by the plurality of media items;
calculating a set of distance scores, wherein each of the set of distance scores represents a distance between the respective set of pose values determined for the respective media item of the plurality of media items and a respective set of pose values determined for an additional media item of the plurality of media items;
determining a coherence score for the plurality of media items based on the calculated set of distance scores; and
responsive to determining that the determined coherence score satisfies one or more coherence criteria, determining that the plurality of media items corresponds to a media trend of a platform.

2. The method of claim 1, wherein identifying the plurality of media items each having the set of common media characteristics comprises:
obtaining audiovisual embeddings for each of the plurality of media items, wherein a respective audiovisual embedding represents one or more audiovisual features of a respective media item; and
determining, based on the obtained audiovisual embeddings, that the plurality of media items share the set of common media characteristics.

3. The method of claim 2, wherein obtaining the audiovisual embeddings for each of the plurality of media items comprises:
obtaining, based on an output of an image encoder, a video embedding representing visual features of the respective media item;
obtaining, based on an output of an audio encoder, an audio embedding representing audio features of an audio signal of the respective media item; and
generating the respective audiovisual embedding based on fused audiovisual data comprising the obtained video embedding and the obtained audio embedding.

4. The method of claim 1, wherein determining the set of pose values for each respective media item of the plurality of media items comprises:
obtaining, for each video frame of a sequence of video frames of a respective media item, a pose embedding representing the particular pose of an object depicted by the respective video frame;
extracting a pose value for the particular pose from the pose embedding; and
updating the set of pose values to include the extracted pose value.

5. The method of claim 4, wherein obtaining the pose embedding comprises:
extracting the pose embedding from one or more audiovisual embeddings associated with the respective media item, or
extracting the pose embedding from one or more outputs of a pose encoder.

6. The method of claim 1, wherein determining the coherence score comprises:
determining a cluster size associated with the plurality of media items, as defined by the calculated set of distance scores, wherein the coherence score reflects the determined cluster size.

7. The method of claim 5, further comprising:
determining, based on at least one of a set of audiovisual embeddings generated for the plurality of media items or a set of textual embeddings generated for the plurality of media items, a creation history for each of the plurality of media items; and
determining a degree of similarity between creation histories determined for respective media items of the plurality of media items, wherein the coherence score further reflects the determined degree of similarity.

8. The method of claim 1, wherein determining that the determined coherence score satisfies the one or more coherence criteria comprises at least one of:
determining that the determined coherence score exceeds a threshold coherence score, or
determining that the determined coherence score is higher than a coherence score for another plurality of media items.

9. The method of claim 1, further comprising:
providing at least one of a set of embeddings associated with the plurality of media items, the determined set of pose values or the calculated set of distance scores as an input to an artificial intelligence (AI) model trained to predict coherence scores for media items of a platform,
wherein determining the coherence score for the plurality of media items based on the calculated set of distance scores comprises extracting the coherence score from one or more outputs of the AI model.

10. A method comprising:
identifying a media item depicting an object having a plurality of distinct poses;
obtaining one or more pose embeddings for the media item, wherein each of the one or more pose embeddings represents a visual feature of a respective distinct pose of the plurality of poses of the object;
identifying one or more additional pose embeddings for an additional media item depicting an additional object, wherein the one or more additional pose embeddings represent additional visual features of additional poses of the additional object;
calculating a distance between the one or more pose embeddings for the media item and the one or more additional pose embeddings for the additional media item; and
determining, based on the calculated distance, whether at least one of the media item or an additional media item are associated with a media trend of a platform.

11. The method of claim 10, wherein obtaining the one or more pose embeddings for the media item comprise:
generating a set of audiovisual embeddings representing audiovisual features of the media item; and
extracting the one or more pose embeddings from the generated set of audiovisual embeddings.

12. The method of claim 11, wherein generating the set of audiovisual embeddings comprises:
obtaining, based on an output of an image encoder, a video embedding representing visual features of the media item;
obtaining, based on an output of an audio encoder, an audio embedding representing audio features of an audio signal of the media item;
generating a respective audiovisual embedding based on fused audiovisual data comprising the obtained video embedding and the obtained audio embedding; and
updating the set of audiovisual embeddings to include the generated respective audiovisual embedding.

13. The method of claim 10, wherein obtaining the one or more pose embeddings comprises:
providing a sequence of video frames of the media item as an input to a pose encoder; and
extracting the one or more pose embeddings from one or more outputs of the pose encoder.

14. The method of claim 10, wherein identifying one or more additional pose embeddings for the additional media item comprises:
accessing a data store that stores embeddings for media items designated as template media items for one or more media trends of the platform; and
extracting the one or more additional pose embeddings from the data store.

15. The method of claim 10, wherein calculating the distance between the one or more pose embeddings for the media item and the one or more additional pose embeddings for the additional media item comprises:
determining a first set of pose values for the first media item based on the one or more pose embeddings and a second set of pose values for the additional media item based on the one or more additional pose embeddings; and
determining a difference between the first set of pose values and the second set of pose values, wherein the calculated distance represents the determined difference.

16. The method of claim 15, wherein the calculated distance between the one or more pose embeddings for the media item and the one or more additional pose embeddings for the additional media item is a Jaccard distance.

17. A method comprising:
identifying a plurality of media items associated with a media trend of a platform;
determining a set of common audiovisual features of the plurality of media items, wherein each of the set of common audiovisual features pertain to the media trend;
identifying, among the plurality of media items, a media item that satisfies one or more template criteria in view of the determined set of common audiovisual features of the plurality of media items; and
determining whether an additional media item is associated with the media trend based on a degree of similarity between audiovisual features of the identified media item and the additional media item.

18. The method of claim 17, wherein determining the set of common audiovisual features of the plurality of media items comprises:
obtaining, for each of the plurality of media items, a set of audiovisual embeddings representing audiovisual features of a respective media item;
identifying one or more audiovisual embeddings that are common to each set of audiovisual embeddings associated with the respective media item of the plurality of media items; and
extracting one or more audiovisual features from the identified one or more audiovisual embeddings.

19. The method of claim 17, wherein identifying a media item that satisfies one or more template criteria in view of the determined set of common audiovisual features comprises:
determining that at least one of:
a number of audiovisual features shared between the media item and the set of common audiovisual features is larger than for other media items of the plurality of media items, or
a degree of similarity between the audiovisual features shared between the media item and the set of common audiovisual features is larger than for other media items of the plurality of media items.

20. The method of claim 17, further comprising:
identifying one or more audiovisual embeddings of the identified media item that corresponds to the determined set of common audiovisual features of the plurality of media items;
designating the identified one or more audiovisual embeddings at a memory as template data associated with the media trend; and
determining the degree of similarity between the audiovisual features of the identified media item and the additional media item based on the designation.
